(19) United States
(12) Patent Application Publication
(10) Pub. No.: US 2008/0032252 A1
(43) Pub. Date: Feb. 7, 2008

(54) ILLUMINATION SYSTEM FOR DENTAL APPLICATIONS

(75) Inventors: Robert Hayman, Los Angeles, CA (US); Christopher Quan, Houston, TX (US)

Correspondence Address: DISCUS DENTAL IMPRESSIONS, INC., 8550 HIGUERA STREET, CULVER CITY, CA, 90232, US

(73) Assignee: DISCUS DENTAL IMPRESSIONS, LLC, Culver City, CA (US)

(21) Appl. No.: 11/764,180

(22) Filed: Jun. 15, 2007

Related U.S. Application Data
(63) Continuation-in-part of application No. 11/173,839, filed on Jun. 30, 2005.
(60) Provisional application No. 60/641,462, filed on Jan. 4, 2005.
(60) Provisional application No. 60/647,723, filed on Jan. 26, 2005.
(60) Provisional application No. 60/647,580, filed on Jan. 26, 2005.
(60) Provisional application No. 60/641,461, filed on Jan. 4, 2005.
(60) Provisional application No. 60/641,468, filed on Jan. 4, 2005.
(60) Provisional application No. 60/647,593, filed on Jan. 26, 2005.
(60) Provisional application No. 60/604,577, filed on Aug. 25, 2004.
(60) Provisional application No. 60/641,469, filed on Jan. 4, 2005.
(60) Provisional application No. 60/814,242, filed on Jun. 15, 2006.
(60) Provisional application No. 60/814,327, filed on Jun. 19, 2006.
(60) Provisional application No. 60/814,239, filed on Jun. 15, 2006.
(60) Provisional application No. 60/814,239, filed on Jun. 15, 2006.
(60) Provisional application No. 60/892,859, filed on Mar. 4, 2007.

(51) Int. Cl. A61C 3/00

(52) U.S. Cl. 433/29

(57) ABSTRACT

A dental illumination system includes an adjustable lamp head including a source of radiation, which may including IR, visible, and/or UV, is provided with an adjustable mounting device adapted for mounting in such a manner that offers freedom of movement for the patient undergoing the procedure, for example, whitening, so that radiation may be directed at the tooth or teeth. In some embodiments, the lamp head includes a housing and a spacer having formations that is adapted to removably mechanically couple the lamp head to a reference device, again having formations, for facilitating illumination of a tooth by a light source contained within the lamp head. The spacer and lamp head may be formed integrally. If formed separately, both the lamp head and the spacer may include formations.

### CROSS-REFERENCE TO RELATED APPLICATIONS

This application is a continuation-in-part of U.S. patent application Ser. No. 11/173,839, filed Jun. 30, 2005, which claims priority to provisional patent application Ser. Nos. 60/641,462, filed Jan. 4, 2005, entitled “Boom Hinge For A Dental Lamp”; 60/647,723, filed Jan. 26, 2005, entitled “Boom Hinge For A Dental Lamp”; entitled “Lamp For Dentistry Applications”; 60/647,580, filed Jan. 26, 2005, entitled “Light Guide For Dental Whitening Lamp”; 60/641,461, filed Jan. 4, 2005, entitled “Support Structure For A Dental Lamp”; 60/641,468, filed Jan. 4, 2005, entitled “Light Guide For A Dental Whitening Lamp”; 60/647,593, filed Jan. 26, 2005, entitled “Support Structure For A Dental Lamp”; 60/604,577, filed Aug. 25, 2004, entitled “Lip Retractors”; and 60/641,469, filed Jan. 4, 2005, entitled “Lamp For Dentistry Applications”; and claims the benefit of U.S. provisional patent applications Ser. Nos. 60/814,242, filed Jun. 15, 2006, entitled “Illumination System for Dentistry Applications”; Ser. No. 60/814,327, filed Jun. 15, 2006, entitled “Illumination System for Dental Applications”; Ser. No. 60/814,239, entitled “Method and Device for Improving Oral Health” filed on Jun. 15, 2006; and Ser. No. 60/892,859, entitled “Device and Method for Improving Oral Health” filed Mar. 4, 2007 the contents of which are hereby incorporated by reference.

### FIELD OF THE INVENTION

This invention relates to illumination systems used in dentistry. Specifically, this invention relates to illumination systems used in dental curing, dental whitening, therapeutic treatment, or imaging.

### BACKGROUND OF THE INVENTION

A tooth is comprised of an inner dentin layer and an outer hard enamel that is coated with a protective layer called the acquired pellicle. The enamel layer is composed of hydroxyapatite crystals that create a somewhat porous surface. The pellicle or the enamel can become stained or discolored. It is believed that the porous nature of the enamel layer is what allows staining agents and discoloring substances to permeate the enamel and discolor the tooth.

Tooth discoloration has a number of causes. For example, the teeth may become stained by coffee or tea drinking, or by the use of tobacco products, or by drinking water with a high mineral content.

One solution to the staining problem is through tooth bleaching. Some dentifrices, like toothpastes, gels, and powders, contain active oxygen or hydrogen peroxide liberating bleaching agents including peroxides, percarbonates and perborates of the alkali and alkaline earth metals or complex compounds containing hydrogen peroxide.

Dental bleaching can be done either in a dental office or at home. Bleaching in a dental office generally employs compositions activatable with the aid of light sources having the appropriate wavelength outputs in order to speed up the process. Additionally, the bleaching compositions used in a dental office typically contain a higher percentage concentration of bleaching agents than the bleaching compositions found in home applications.

In addition to staining, tooth decay, resulting in cavities or other damages can also result. In the field of tooth restoration and repair, dental cavities are often filled and/or sealed with compounds that are photosensitive, either to visible and/or ultraviolet light. These compounds, commonly known as light-curable compounds, are placed within dental cavity preparations or onto dental surfaces and are cured when exposed to light from a dental curing light device.

Unlike dental curing and imaging processes, which are generally relatively fast processes, dental bleaching takes a much longer time, sometimes amounting to more than an hour per office visit. On the other hand, dental restoration is often an unwelcome experience. Therefore, it is advantageous that a person undergoing the processes, either dental restoration or bleaching, be as comfortable as possible.

The process is generally performed in a dentist's chair. Typically a dentist's chair has a wide range of adjustability such that a patient may be placed in a wide range of positions from a nearly full reclining position to a nearly upright position. In order to effectively accomplish the whitening or restoration process, a light source needs to be aligned with the mouth. The wide range of dentist's chair positions can make this alignment difficult.

Further considerations in the process of dental procedures include the ability to maintain cleanliness of the light source, and particularly of any part that comes into contact with the patient. Further, the process of whitening is, for example, optimized, that is, the light source is on as long as necessary to whiten the teeth to the desired degree. Still further, it is desirable that the light source be as efficient as possible. An efficient lamp tends to be cooler and therefore safer than an inefficient lamp. Also, an efficient lamp requires less energy to run than an inefficient lamp.

It remains desirable to have an efficient and comfortable apparatus and method for dental whitening, curing and imaging.

### SUMMARY OF INVENTION

The present invention is directed to a system an apparatus and method for dental whitening, curing, therapeutic treatment, or imaging that offers freedom of movement for the patient during the dental process.

In one aspect, the present invention is directed to an alignment system to facilitate faster patient set up and optimal results. In another aspect, the present invention is directed to efficacy of procedure with minimal disruption. In one embodiment the alignment system includes an apparatus for positioning a dental illumination device relative to a subject, including a lamp system and reference device for engaging the lamp system for positioning the lamp system at a predetermined distance from the target. The lamp system includes a lamp head. The reference device includes a light distributor. Examples of the light distributor includes a light pipe, a light guide; a mouthpiece, a tongue illuminator, an illumination plate, a dental tray, a dental floss, or combinations thereof.

In another embodiment, the alignment system includes an apparatus for positioning a dental illumination device relative to a subject, including a lamp system, a spacer, and a reference device, wherein the spacer is adapted for engaging both the lamp system and the reference device for positioning the lamp system at a predetermined distance from the reference device.

In one aspect, the lamp head may include a housing and a spacer having formations that are adapted to removably mechanically couple the lamp head to at least one reference device, also having formations, for facilitating illumination of a tooth by a source of radiation, which may be IR, visible, and/or UV, contained within the lamp head. The spacer and lamp head may be formed integrally. If formed separately, both the lamp head and the spacer may include formations. The reference device may be adapted to be worn on at least a portion of a person undergoing treatment, thus permitting such person some freedom of movement during treatment without disrupting the treatment process. In one embodiment, at least one reference device may be worn intra-orally. In another embodiment, the reference device and the spacer include formations that removably inter-engage as the reference device and spacer become apposed.

In one embodiment, the spacer and the lamp system include formations that removably inter-engage as the spacer and the lamp system become apposed.

In another embodiment, the spacer and at least one of its formations are integrally formed with the lamp system.

The inter-engaging formations may serve to stabilize the spacer axially and against twisting.

In another aspect, the lamp head may include a housing having formations that are adapted to removably or permanently mechanically couple the lamp head to the reference device, also having formations, for facilitating illumination of a tooth by a source of radiation, as noted above. The reference device is adapted to be worn on at least a portion of a person undergoing treatment, thus permitting such person some movement during treatment without disrupting the treatment process.

In one embodiment, the reference device may be a part of a headset. In another embodiment, the reference device may be a part of an eye-wear frame.

In one embodiment of the invention, the dental illumination system may include an optical filter system to modify the optical and/or physical properties of the light coming from the light source or to alter the nature of a therapeutic light treatment. The optical filter system may include a filter, a diffuser or combinations thereof.

In one aspect, the filter system may be positioned in or out of the direct path of the light source. In one embodiment, the spacer may include a filter system that may be removably attached to it. In another embodiment, the lamp head may include a filter system that may be positioned in or out of the direct path of the light source. In a further embodiment, the lamp head may include a filter system that may be removably attached to it. In another aspect, the filter system may be positioned in the direct path of the light source and be electronically controlled to either change or not change the nature of the nature of the light coming from the light source. In one embodiment, the filter system may be completely transparent to the light coming from the light source so that it will transmit 100% of the light as is. In another embodiment, the filter system may have varied effect on the light coming from the light source, for example, only transmitting a wavelength and blocking another wavelength.

In one embodiment, the spacer, if present, may be adapted to be connected to a reference device that forms part of a headphone-type light source positioning device. In another embodiment, the spacer may be connected to a reference device that forms part of an eye-wear type light source positioning device.

The present invention further relates to an illumination system including an adjustable mounting device for mounting the lamp head so that radiation may be directed at the oral cavity, for example, a tooth or teeth of a patient undergoing a dental procedure aided by the radiation source and may additionally be fitted with a dental tray containing whitening solution or gel.

In one embodiment of the invention, the adjustable mounting device may include one of the reference devices and may include at least one arm adapted to swing in from an eyewear-type frame. In one aspect, at least one other reference device may be used which may be a retracting device that is adapted to aid in the accurate positioning of the lamp head.

In one embodiment, the retracting device may be a lip retractor. In another embodiment, the retracting device may be a cheek retractor.

In a further embodiment of the invention, the adjustable mounting device may include one of the reference devices and may include at least one arm adapted to swing in from a headphone-type frame. In one aspect, at least one other reference device may be a retracting device that is adapted to aid in the accurate positioning of the lamp head.

Furthermore, the present invention includes a support mechanism that is unobtrusive, easily adjustable, and able to provide positioning in multiple degrees of freedom so as to be adaptable to the requirements of patients of various sizes.

The lamp system and a support system include formations that removable inter-engage as the lamp system and the support system become apposed.

The lamp system in the present invention may be, for example, a light weight apparatus, to facilitate wearing it on a patient's person without un-necessarily burdening the patient undergoing the treatment.

In one embodiment, the arrangement of the light source or sources may be effectively configured to achieve the target radiometric power at the target zone. Factors such as variability of emitter light output and voltage drop, light spray as well as the proximity of array to mouth and related issues (such as clinician access, claustrophobia) may be balanced for optimal results.

According to a first embodiment of the invention, a dental whitening, therapeutic or curing light source includes at least one light source such as, for example, an ultraviolet light source for activating a dental whitening or curing composition. The light source may include a lamp, an arc lamp such as a halogen light source, semiconductor light emitting devices, light-emitting chips such as an LED, a solid state LED, an LED array, a fluorescent bulb, and so on. In the case of dental imaging, the light source may include the above in addition to a laser, an x-ray or even an infrared source.

According to a second embodiment of the invention, multiple light sources arranged in a geometric arrangement may be used. In one aspect, an illumination frame may be disposed inside the lamp head housing. In another aspect, the illumination frame may be in place of the lamp head housing as a self-contained structure. In a further aspect, the illumination frame may be in addition to the lamp head housing. The light sources may be collectively powered or individually powered. If individually powered, each of the individual light sources may be turned on or off separately, as desired.

In one embodiment, the illumination frame may be adapted to be coupled to the spacer and the spacer is adapted to be coupled to the reference device. In another aspect, the spacer may be an integral part of the lamp system, adapted to be coupled to the reference device. According to a further aspect, an illumination frame includes at least one light source set in the illumination frame to illuminate at least one tooth in the mouth of a dental patient.

In one embodiment, the illumination frame may, for example, conform to the jaw of a patient and have a first end and a second end. The first and second ends include a first and second formation, such as slots, configured to mate with a first and a second formation, such as a wing-like member, respectively, of a reference device such as a lip retracting device. The arcuate shape of the illumination system may be configured to follow the curvature of the human head so that the light sources are substantially equidistant from the various teeth in a dental patient. The light source may be capable of whitening, curing or imaging.

In another embodiment, the illumination frame is rectangular with a first slotted structure on one side of the rectangle and a second slotted structure on the opposite side of the rectangle configured to mate with wing-like members on a lip retracting device worn by a dental patient.

In one embodiment of the invention, a path is provided from a light source to a target such as a whitening or therapeutic composition disposed on a tooth surface, a filling compound residing either on the surface or in the cavity of a tooth, or a tooth for imaging. In one aspect, the light path includes a light source capable of imaging, whitening, curing or providing therapeutic effects. Therapeutic effects as use herein may include exposing to a therapeutically effective amount of light to improve oral health; a therapeutically effective amount of both light and an oxidizing agent to improve oral health; a therapeutically effective amount of both light and at least one auxiliary chemical agent that increases the susceptibility of oral bacteria to light; or a therapeutically effective amount of light while simultaneously being subjected to an auxiliary or therapeutically effective physical or mechanical action. An “effective amount” or “therapeutically effective amount” refers to the amount of light and optional agent or action which is required to confer therapeutic effect on the treated subject. In another aspect, the light path includes a light source and at least one reflector integral to the light source. According to a further aspect, the invention includes a second reflector having an axial cavity with a first aperture at an end proximate the light source and a second aperture distal to the light source. The second reflector includes a reflective internal surface adapted to direct light from the light source towards the second aperture by reflection. In one embodiment, an optical lens is disposed within the second reflector. According to another embodiment, the optical lens includes at least one curved surface and is adapted to direct light from the light source towards the second aperture by refraction. According to yet another embodiment, an optical filter system is disposed coincident with the second aperture. The optical filter system serves to impede the passage of various wavelengths of light while allowing the passage of other wavelengths, or allowing a more uniform illumination of the target, respectively. In one aspect, the optical filter system may be positioned in front of the spacer when the spacer is positioned in front of the light source. In another aspect, the optical filter system may be positioned within the lamp housing. In a further aspect, the optical filter system may be removably mounted at the front of the lamp housing to vary the amount and/or the wavelength of the light emitting from the light source. The attachment may be effected by an adhesive, a friction fit, and/or mechanical attachment (such as a bolt or bolts, a screw or screws, other similar attachment methods, or combinations thereof. Other attachment methods for enabling clip-on, snap-on, etc. may be used. The filter may also be adapted for swinging up, down or away from the spacer or lamp housing. In a further embodiment, the optical filter serves to prevent, for example, most light having a wavelength characterized as in the infrared range from passing through the second aperture to the target, if desired. In contrast, light in the ultraviolet and/or visible ranges are allowed to pass, if desired. In another aspect, the filter system may be permanently positioned in the direct path of the light source and be electronically controlled to either change or not change the nature of the nature of the light coming from the light source. In one embodiment, the filter system may be completely transparent to the light coming form the light source so that it will transmit about 100% of the light as is. In another embodiment, the filter system may have varied effect on the light coming from the light source, for example, only transmitting a wavelength and blocking another wavelength.

According to a further embodiment of the invention, a light path apparatus including a reflector, a lens, a filter, and a diffusion element is disclosed. The diffusing element may be used to spatially homogenize the spectrum output of a light source.

According to one embodiment of the invention, the diffusing element is disposed between the light source and a lens. The lens serves to refract light received from the light source, directly or indirectly, by reflection from various surfaces, and to refract light towards the target area.

According to another embodiment of the invention, a light path apparatus including a reflector, a lens, a filter, an integrator and diffusing element is disclosed. In one aspect, according to various embodiments of the invention, a light path apparatus includes a housing having a reflector surface and an integrator surface. The reflector surface redirects divergent rays of light towards an input of a lens, or lens system. The integrator surface redirects divergent rays of light received from an output surface of the lens or lens system towards an output aperture of the light path apparatus.

In still another embodiment of the invention, the light path apparatus includes an optical filter. The optical filter serves to absorb and/or reflect light of various wavelengths, and in particular wavelengths of desirable ranges in terms of the applications of the dental lamp system. For example, where an output of the dental lamp is desired to be principally within the ultraviolet spectrum, the optical filter will absorb and otherwise reject at least some light of visible and/or infrared wavelengths.

In one embodiment of the invention, the optical filter is disposed distal to the light source, such that the diffuser element and lens are disposed between the light source device and the optical filter. In one embodiment of the invention, the optical filter is disposed immediately adjacent to, or within, an aperture at an output and of the light path apparatus. Consequently, light suitable for activating a dental whitening compound, a therapeutic agent, or for any other dentistry process, is available outside of the second aperture, if present. Meanwhile, for example, infrared light, which would otherwise unduly elevate the temperature of the target area, unless useful in a dental process, is excluded from the target area, or is reduced to acceptable levels.

According to at least one embodiment of the invention, an elastomeric mounting is provided to mechanically couple the filter in position in the light path. Furthermore, one embodiment of the invention includes another elastomeric mounting disposed to mechanically couple the optical lens to a position in the light path. The elastomeric mountings serve, in various aspects of the invention, to protect the lens and filter respectively against mechanical shock and to compensate for differences in coefficient of thermal expansion present between various materials employed in the device of the invention. As noted above, the filter may also be adapted to swing in and out of the path of the light source, in the manner of how a sun shade works. The filter may be used during one dental process and be moved out of the way during another process.

According to a further embodiment of the invention, a light source and reflector assembly are disposed within a lamp housing. The lamp housing includes fixturing features adapted to hold the light source and a reflector assembly within an axial cavity of the lamp housing. The lamp housing includes a rear aperture proximate to the light source and a front aperture proximate to the second aperture of the reflector.

According to at least one embodiment of the invention, at least one wavelength transformer may be included. The wavelength transformer may act to transform shorter wavelengths outside of the useful range for whitening imaging or curing, into longer wavelengths in the useful range, thus minimizing energy waste. In one aspect, the wavelength transformer may be disposed within the lamp housing. In another aspect, the wavelength transformer may be part of the light source. In a third aspect, the wavelength transformer may be constructed into a modular device adapted to be installed or removed from the lamp housing of the whitening, imaging or curing light source, whenever desired.

In another embodiment of the invention, a grill is disposed coincident with the rear aperture. In one aspect, the grill includes perforations for heat dissipation or to allow the passage of a cooling medium, such as air.

In one embodiment of the invention, the lamp housing also includes a cooling system for maintaining the light source, and other components of the lamp head at a desirable temperature, a high operating temperature of the light source notwithstanding. In one embodiment, the cooling system includes a fan. In another embodiment, the cooling system includes a heat sink. In still another embodiment, the cooling system includes heat pipes. In another embodiment, the cooling system includes phase change materials.

According to one embodiment of the invention, the housing includes a formation such as a mechanical coupling feature in proximity to the front aperture. The mechanical coupling feature provides, according to one embodiment of the invention, a secure, removable connection between the housing and a spacer.

Housing as used herein may include structures that contained a light source or sources.

In one embodiment of the invention, the spacer may be, for example, a light guide, having a first and a second formation. The first formation is adapted to removably couple the light guide to a light source or lamp, and the second formation is adapted to removably couple the light guide to a reference device for positioning the light guide, and consequently the lamp head and/or a light source, in a substantially constant position and orientation with respect to a target. In one aspect, the light guide may have a substantially tubular or substantially ellipsoidal shape. An aperture at a proximal end of the light guide is adapted for positioning the light guide adjacent to the front aperture of the lamp housing. A further aperture exists at a distal end of the light guide. The light guide includes formations adapted to interface with the formations of the housing. The light guide may include a second formation adapted to removably couple the light guide to a reference device for positioning the light guide, as noted above, and consequently the lamp head and the light source, in a substantially constant position and orientation with respect to a target.

In one embodiment, the light guide may be formed of a polymeric material having a spectral absorption characteristic, for example, visible light may readily pass through the walls of the light guide, while ultraviolet light may be either absorbed by the walls or, for example, may be reflected from the internal surfaces of the light guide. By allowing the transmission of visible light the light guide facilitates the installation of the light guide since the teeth of the patient may be quite visible through the walls of the light guide. By absorbing or reflecting light of ultraviolet wavelengths, the light guide serves to contain the ultraviolet radiation directed therethrough and to shield local soft tissues and/or tongue from the effects of such ultraviolet radiation.

The material of the light guide may be chosen to absorb and/or reflect light of one or more ranges of wavelength that impinges on the tubular inner surface. Consequently, according to one aspect of the invention, the light guide may reduce the degree to which light of the subject wavelengths escapes from the system except through the distal aperture of the light guide.

In another embodiment of the invention, the light guide is adapted to be limited to the use in the treatment of a single dental patient and may be thereafter disposable. In another embodiment, a control mechanism may be provided to inhibit the use of a light guide on additional patients after it has been once used. One aspect of the control mechanism is that the inhibition may occur during the attachment process of the light guide to the lamp system.

According to one embodiment, a single-use light guide includes a write once read many times (WORM) memory device. In a particular aspect of the invention, the WORM memory device is adapted to receive a signal related to the duration of use of a related instance of a light guide, and to substantially indelibly record the information content of the signal for later use by a control subsystem of a light source.

In a further embodiment of the invention, a plurality of light guides each have an output end having a respective size, wherein the size of a particular output end corresponds to a mouth size of a particular patient or class of patients. For example, light guides in various embodiments may be provided that are most appropriate to use by a large adult, a small adult, or a child.

In one embodiment of the invention, the reference device is a lip retracting device having geometric formations adapted to receive one or more lips of a patient in a tooth restoration, imaging, whitening process or therapeutic session.

In one aspect, the light guide and the lip retracting device provides an interlocking system for optical alignment of the light source with the target, allowing for fool-proof set up, promoting patient safety during a dental procedure, and facilitating some patient movement without disrupting the procedure.

In another aspect, soft foam or elastomeric cushions are disposed along the edge of the light guide that interfaces with the lip retracting device to provide custom forming to each patient's profile for additional comfort.

In one embodiment, the light guide includes air vents for patient breathing comfort during the bleaching or curing treatment or during imaging.

According to the present invention, the reference device may include a lip retracting device having formations adapted for repeatably positioning a user's lips with respect to a light output port, a light guide, an examination or an imaging device such as a cone-shaped structure.

In one embodiment of the present invention, a lip retracting device includes at least two channel retainers or flanges, at least one resilient member, and at least two wing-like members or flanges, wherein each of the channel retainers includes a race, an inside side wall, an outside side wall, and each of the wing-like members is spaced away from the attachment of the resilient member. Each of the wing-like members may be adapted to fit into a formation such as a slot in an output port, a light guide, an examination or an imaging device such as a cone. In one aspect, each of the resilient members is attached to the inside side wall of two adjacent channel retainers by means of an adhesive or heat sealing, and includes two arches; and each of the wing-like flanges or members is attached to a channel retainer by means of an adhesive or heat sealing. In another aspect, each of the resilient members is integrally molded to the inside side wall of the two adjacent channel retainers and includes two arches; and each of the wing-like flanges or members is integrally molded to a channel retainer.

According to another embodiment of the invention, a lip retracting device includes at least a pad attached or molded to the resilient member about the area of the arch.

According to yet another embodiment of the invention, a lip retracting device includes at least two channel retainers, at least two wing-like flanges and a tongue retainer, the channel retainers being held in a spaced apart relationship by at least one resilient member, the wing-like flanges being integrally attached or molded to the channel retainers and the tongue retainer being attached to two of the channel retainers.

According to a still further embodiment of the invention, a lip retracting device includes at least two pads, attached or molded to a resilient member.

According to still another embodiment of the invention, there is provided a lip retracting device for accommodating a dental treatment composition, for example, a whitening composition. In one aspect, the retracting device may further include a u-shaped channel configured to accommodate the lower, or alternatively the upper, set of a user's teeth. The u-shaped channel supports the channel retainers in substantially fixed spatial relation with respect to one another. In another aspect, the arch of the retracting device may be configured to accommodate a u-shaped channel.

In one aspect, any of the lip retracting devices described above may be fitted with a tab for grasping and for facilitating insertion and removal.

In one embodiment, the lip retracting device may also be adapted for use by a single patient and is thereafter disposable. One aspect of the control mechanism is that the inhibition occurs during the attachment process of the lip retracting device to the light guide.

In a further embodiment, a reference device may be held in place by the natural compression of the lips of the patient. The device includes wings that provide positioning and alignment to a mating formation on an imaging apparatus. The configuration enables patients to hold a position during imaging with comparatively little effort.

In one aspect, a reference device includes a passively held portion to anchor it to a subject of dental imaging. The reference device further includes a first alignment formation coupled to the passively held portion where the first alignment formation provides alignment to at least one dental feature. The reference device further includes a second alignment formation coupled to an imaging device where the second alignment formation is shaped and configured to mate with the first alignment formation to the imaging device in a substantially fixed position with respect to the at least one dental feature. The reference device may include a film holder coupled to the passively held portion. The film holder locates imaging film, or an imaging sensor, for imaging the at least one dental feature.

In one embodiment, the reference device may be a single-use device, and the imaging film, or imaging sensor may be integrally formed with the holder.

In another embodiment, the reference device may be a mounting device, as discussed above.

In one embodiment, the dental lamp or light source may be powered by a power pack which may have a display panel for displaying the status of a dental process. In another embodiment, the pack may include a voice alert system for alerting the dental professional of the status of a dental process.

In one embodiment, at least portions of the whitening composition may be in a tray. The tray may be positioned in the patient's mouth using a reference device such as a lip retracting device.

In another embodiment of the invention, an illumination frame may be mounted to a lamp head. In one arrangement, the lamp head provides support for the illumination frame. In another arrangement, the lamp head provides power to the illumination frame.

In another embodiment of the invention, the dental illumination frame includes a plurality of light sources emitting light of substantially the same wavelength. In another embodiment of the invention, the dental illumination frame includes a plurality of light sources emitting light of different wavelengths.

In yet another embodiment of the invention, the dental illumination system has an arcuate illumination frame having tapered ends. The tapered ends result in less bulk in the illumination frame close to the patient's mouth. In an alternative arrangement, each of the tapered ends includes a slot wherein the slots are configured to mate with wings of a lip retracting device worn by a dental patient.

The present invention together with the above and other advantages may best be understood from the following detailed description of the embodiments of the invention illustrated in the drawings below.

### BRIEF DESCRIPTION OF THE DRAWINGS

FIG. 1 shows, in perspective view, a dental whitening, dental therapeutic or curing lamp according to one embodiment of the invention;

FIG. 2 shows, in cross section, various components of a whitening, dental therapeutic or curing lamp head, according to one embodiment of the invention;

FIG. 3 shows, in assembly drawing format, several components of a dental whitening or curing lamp according to one embodiment of invention;

FIG. 4 shows, in perspective view, a grill and an electrical connector of a lamp head according to one embodiment of the invention;

FIG. 5 shows, in perspective view, an illumination frame according to one embodiment of the invention;

FIG. 5-1 shows, in perspective view, an illumination frame with tapered ends according to one embodiment of the invention;

FIG. 5a shows, in perspective view, an illumination frame according to one aspect of the illustrated embodiment;

FIG. 5b shows, in perspective view, an illumination frame having a non-reflective surface according to one embodiment of the invention;

FIG. 5c shows, in perspective view, an illumination frame with an electrical connector according to one embodiment of the invention;

FIG. 5d shows, in perspective view, an illumination frame having a rectangular shape according to one embodiment of the invention;

FIG. 5e shows, in perspective view, the illumination frame of FIG. 12 with slots to mate with a lip retracting device according to one embodiment of the invention;

FIG. 5f shows an embodiment of an illumination frame including a heat sink;

FIG. 6 shows, in perspective view, an illumination frame having slots according to one embodiment of the invention;

FIG. 7 shows, in perspective view, another embodiment of an illumination frame;

FIG. 8 shows, in exploded perspective view, a light guide having a recording device and an elastic protector;

FIG. 9 depicts a semi-schematic perspective view of an alternative lip retracting device provided in accordance to another embodiment of the present invention;

FIG. 10 depicts a semi-schematic top plan view of the lip retracting device of FIG. 9;

FIG. 11 depicts a semi-schematic side view of the lip retracting device of FIG. 10 fitted with pads;

FIG. 12 depicts a perspective view of an embodiment of a lip retracting device having a u-shape channel;

FIG. 12a shows, in perspective view, a lip retracting device having extended wings according to one embodiment of the invention;

FIG. 12b shows, in perspective view, a lip retracting device including targets according to one embodiment of the invention;

FIG. 12c shows, in perspective view, a lip retracting device with extended wings and targets according to an embodiment of the invention;

FIG. 13 depicts a perspective view of an embodiment of a lip retracting device having a u-shape channel with a tab;

FIG. 14 shows, in perspective view, a lip retracting device accommodating both lower and upper sets of teeth according to one embodiment of the invention;

FIG. 15 shows an exploded view of the combination of a lip retracting device with the light guide and a lamp;

FIG. 16 shows a side profile view of a head-mounted dental system in one embodiment of the invention;

FIG. 16a shows a front view of the head-mounted dental system of FIG. 16 in one embodiment of the invention;

FIG. 16b shows an embodiment of positioning member for a dental apparatus in one aspect of the invention;

FIG. 16c shows an embodiment of positioning member for a dental apparatus in another aspect of the invention;

FIGS. 17 and 17a show a perspective view of a head-mounted dental apparatus in one embodiment of the invention;

FIG. 17b shows a rear view of the embodiment of FIG. 17a;

FIG. 18 shows a front view of a head-mounted dental apparatus in one embodiment of the invention;

FIG. 18a shows a side profile view of the head-mounted dental apparatus of FIG. 18 in one embodiment of the invention;

FIG. 19 shows a front view of a head-mounted dental apparatus in one embodiment of the invention;

FIG. 19a shows a side profile view of the head-mounted dental apparatus of FIG. 19 in one embodiment of the invention;

FIG. 20 shows a side profile view of a head-mounted dental apparatus in one embodiment of the invention;

FIG. 20a shows a front view of the head-mounted dental apparatus of FIG. 20 in one embodiment of the invention;

FIG. 20b shows a side profile view of a head-mounted dental apparatus with weight reducing features in one embodiment of the invention;

FIG. 20c shows a front view of a head-mounted dental apparatus of FIG. 20b in one embodiment of the invention;

FIG. 21 shows a perspective view of a dental chair mounted dental apparatus in one embodiment of the invention;

FIG. 22 shows a perspective view of a portable wearable dental apparatus in one embodiment of the invention;

FIG. 23 shows a perspective view of a face-mounted dental apparatus in one embodiment of the invention;

FIG. 23a shows a perspective view of a head mounted dental apparatus in another embodiment of the invention;

FIG. 24 shows an exploded view of the combination of a light guide, optical filter system and a lamp;

FIG. 24a shows, in perspective view, a lamp with an optical filter system;

FIG. 24b shows an embodiment of a light guide with an integrated optical filter system;

FIGS. 25, 25a and 25b show radiometric power data of a light emitter;

FIGS. 26a and 26b show examples of the ranges of motion and adjustment possible with an embodiment of a head-mounted dental apparatus in one embodiment of the invention;

FIGS. 26c and 26d show free body diagrams illustrating the centers of mass and moment arms of an embodiment of a head-mounted dental apparatus in one embodiment of the invention;

FIGS. 27, 27a and 27b show options, data and an example of cooling systems for use with some embodiments of the invention;

FIGS. 28 and 28a show embodiments of head-mounted dental apparatuses with integrated cooling systems;

FIGS. 28b and 28c show embodiments of base units for dental apparatuses with integrated cooling systems;

FIGS. 29 and 29a show embodiments of base unit design for dental apparatuses;

FIGS. 30-30f show embodiments of base unit and user interface design for dental apparatuses;

FIG. 31 shows an electrical system block diagram for a dental apparatus utilizing LED light sources;

FIG. 32-32k show calculations, nomenclature and notes for calibration and evaluation of light sources utilized on a patient's teeth in some aspects of the invention;

### DETAILED DESCRIPTION OF THE INVENTION

The detailed description set forth below is intended as a description of the presently exemplified tooth bleaching and dental material curing methods and apparatus provided in accordance with aspects of the present invention and is not intended to represent the only forms in which the present invention may be prepared or utilized. The description sets forth the features and the steps for preparing and using the tooth bleaching, dental therapeutic and dental material curing methods and apparatus of the present invention. It is to be understood, however, that the same or equivalent functions and components incorporated in the tooth bleaching, therapeutic treatment and dental curing methods and apparatus may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The present invention is directed to an illumination system for dental whitening, therapeutic treatment, imaging or curing. The lamp system may provide a therapeutic effect to the oral cavity, may activate a whitening substance, a therapeutic composition, or filling composite applied to a patient's teeth and/or gums with light from a light source. The illumination system maximizes patient comfort, patient relaxation, minimizes perception of confinement, and ensures efficacy of procedure with minimal disruption. It further offers the dental professional a way to minimize footprint of equipment, proper fit into a dental environment, increases perception of sophisticated equipment and professional experience, portability, ease of patient alignment, ease of cleanup and changeover, and ease of monitoring and operation.

In dental whitening, cleaning and/or bleaching agents are applied to the teeth of a patient, for example. In tooth repair or restoration, composite filling materials are applied to surface and/or cavity in a tooth. In dental treatment, a therapeutic agent may be applied to the tissues, tongue, gums and/or tooth or teeth. The bleaching agents, therapeutic agents, and/or composite materials are activated by the application of energy, such as, for example electromagnetic energy. In imaging, the light source produces an image of the tooth or teeth of a patient, either by direct imaging, for example, using x-rays, or by indirect imaging or trans-illumination.

For effective activation or imaging while reducing spurious heating of the teeth and surrounding tissues and/or tongue, electromagnetic energy of a particular wavelength, optimized for, for example, the activation of the particular chemicals in use, may be provided. For example, it is known to apply radiation in the visible and ultraviolet domains from a light source to the tooth or teeth of the dental patient to activate a whitening compound or filling composite.

Another way of enabling effective chemical activation of a dental whitening compound is to position a light source to fully illuminate the tooth surfaces being treated.

Since light intensity varies as the inverse cube of distance from a light source, it is desirable that the light source used be in reasonably close proximity to the tooth surfaces being treated. Also, because some of the light effective for chemical activation of a dental whitening or curing compound, or for imaging may also be deleterious to soft tissues, it is desirable to minimize the exposure of a patient's gums, tongue, facial skin and other soft tissues to the light source.

In view of these considerations, it is desirable that an illumination system be capable of rapid and reliable positioning of the light source in proximity to a patient's teeth or mouth, while permitting some patient movement without disruption the process.

To accomplish this, a reference device, such as a lip retracting device or a cheek retracting device, and a spacer, such as a light guide, include formations that may inter-engage as the reference device and spacer become apposed, in one aspect. In another aspect, the spacer and the lamp system include formations that removably inter-engage as the spacer and the lamp become apposed. The inter-engaging formations may serve to stabilize the spacer axially and against twisting. In a further aspect, a reference device includes a support system. The lamp system may include formations that inter-engage to facilitate supported positioning of the light source while permitting some patient movement without disrupting the dental treatment process as the lamp system and the support system become apposed.

In other embodiments, the reference device may include at least one light pipe, at least one light guide; a mouthpiece, a tongue illuminator, an illumination plate, a dental tray, a dental floss or combinations thereof, as noted above. Embodiments of the light distributor are described in more detail in U.S. patent application Ser. No. 11/344,974, and U.S. provisional application Ser. No. 60/814,239, entitled “Method and Device for Improving Oral Health” filed on Jun. 15, 2006; and Ser. No. 60/892,859, entitled “Device and Method for Improving Oral Health” filed Mar. 4, 2007, the contents of which are hereby incorporated by reference.

The word formation as used herein in relation to the reference device, spacer, the lamp system and a support system refers to the portion of the reference device, spacer and lamp system which is shaped to inter-fit with a corresponding part of an adjoining component. It includes portions of the above listed article which are shaped by molding, or portions which are formed separately and then subsequently assembled.

Suitable inter-engaging formations include tongues and grooves, posts and sockets, swingable hooks and sockets, resilient clips and sockets, tongue or wing-like members and slots, ball and cavity, ball and socket, some of which are more specifically exemplified in detail below.

The dental process includes protecting a patient's soft tissues and/or tongue which typically involves applying a soft overlay such as a sheet of rubber or foam over the patient's gums and other soft tissue and/or tongue. In a curing process, the overlay maybe applied to the unaffected teeth as well. The patient's soft tissues and/or tongue may alternatively be protected by, for example, opaque gauze pads or by non-UV light-curable, UV light-blocking masking chemicals. After the patient's soft tissues and/or tongue have been protected, a whitening composition or a filling composite is applied to the teeth or tooth. For a therapeutic treatment process, the protective layer may only block the harmful wavelength, while allowing therapeutic light to penetrate, to kill or eliminate harmful bacteria, or to activate a therapeutic agent to kill or eliminate harmful bacteria that causes periodontal diseases, bad breath, or to have a therapeutic effect on the gum tissue, tongue or other parts of the oral cavity, including teeth. Calcium and iron chelators may also be used with oxidizing agents to eliminate or reduce bacteria in the oral cavity, or to make the bacteria more susceptible to killing by light. The chelators may be found in U.S. patent publication nos. 20050064371, 20050221251, 20050048434, 20050265933, and 20030198605 the contents of which are hereby incorporated by reference; and U.S. Pat. Nos. 6,162,055, 6,343,933, 6,416,319, the contents of which are hereby incorporated by reference. The composition is then activated with light from the lamp system.

The rubber material useful for the soft overlay may include either natural or synthetic rubber. Synthetic rubbers may be, for example, elastomeric materials and may include, but not limited to, various copolymers or block copolymers(Kratons®) available from Kraton Polymers such as styrene-butadiene rubber or styrene isoprene rubber, EPDM (ethylene propylene diene monomer) rubber, nitrile (acrylonitrile butadiene) rubber, latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above; or any biodegradable or biocompostable polyesters such as a polylactic acid resin (comprising L-lactic acid and D-lactic acid) and polyglycolic acid (PGA); polyhydroxyvalerate/hydroxybutyrate resin (PHBV) (copolymer of 3-hydroxy butyric acid and 3-hydroxy pentanoic acid (3-hydroxy valeric acid) and polyhydroxyalkanoate (PHA) copolymers; and polyester/urethane resin. In general, any material capable of blocking harmful light to the tissues and/or tongue, may be used. For the therapeutic process, any material capable of minimizing harmful wavelengths while admitting therapeutic wavelengths may be used.

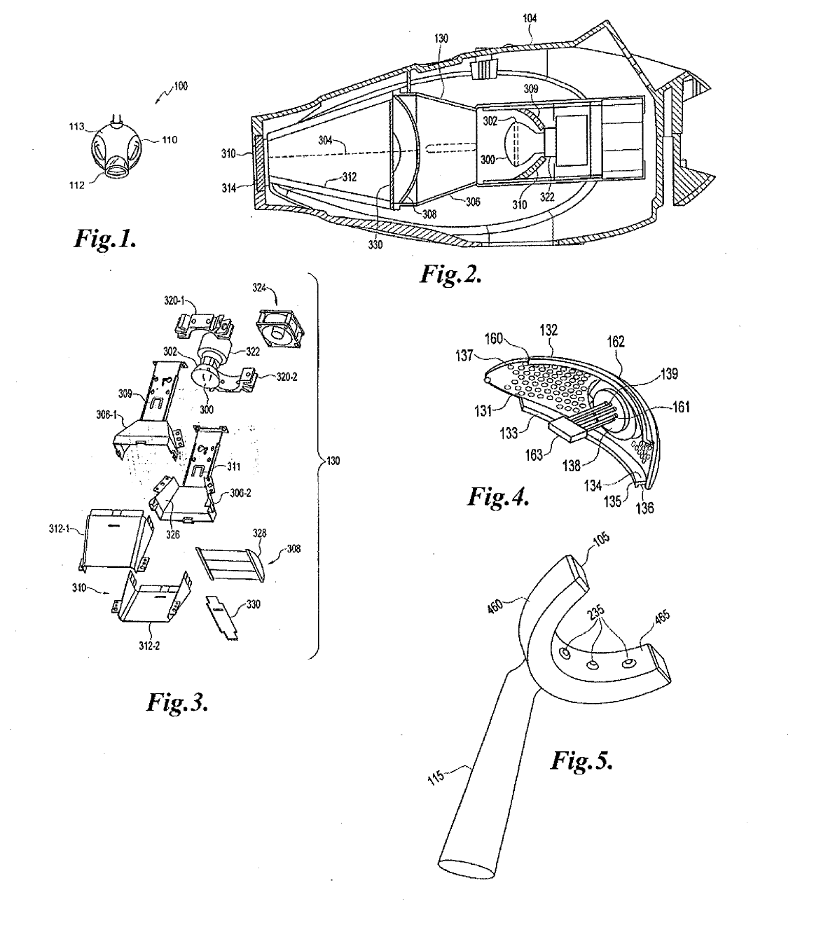

FIG. 1 is a perspective view of a dental whitening, imaging, therapeutic or curing lamp system 100 according to one embodiment of the present invention. The lamp 100 includes a lamp head 110 having a lamp head housing 113 and a light guide 112. The lamp head 110 provides the light that, for example, activates a whitening substance, a therapeutic composition or curing composite applied to a patient's teeth by directing the light through the light guide 112. This lamp system 100 may be used in a dental office or a dental laboratory. Details of this lamp system may be found in U.S. patent application Ser. No. 11/173,839, entitled “Illumination Systems for Dentistry Applications”, the content of which is hereby incorporated by reference.

The lamp housing 113 and head 110 may be made of any polymeric material, for example, a polymer that can be molded or cast; or a metal or metallic alloy. Suitable polymers include polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used. For example, a blend of polycarbonate and ABS (Acrylonitrile Butadiene Styrene) may be used for the lamp housing and head.

Generally, polymeric materials or composites having high temperature resistance are suitable.

Suitable metal or metallic alloys may include stainless steel; aluminum; an alloy such as Ni/Ti alloy; any amorphous metals including those available from Liquid Metal, Inc. or similar ones, such as those described in U.S. Pat. No. 6,682,611, and U.S. Publication No. 2004/0121283, the entire contents of which are incorporated herein by reference.

A liquid crystal polymer or a cholesteric liquid crystal polymer, one that can reflect rather than transmit light energy, may be used, either as a coating or as the main ingredient of the housing 113 and/or lamp head 110, to minimize escape of light energy, as described, for example, in U.S. Pat. Nos. 4,293,435, 5,332,522, 6,043,861, 6,046,791, 6,573,963, and 6,836,314, the contents of which are incorporated herein by reference.

The light guide 112 may also be made of similar materials as discussed above for the lamp housing 113 and lamp head 110. Additionally, like the lamp housing 104 and the lamp head 110, a cholesteric liquid crystal polymer, one that can reflect rather than transmit light energy, may be used either as a coating or as the main ingredient of the light guide to minimize escape of light energy, as described, for example, above.

The light source of the embodiment described above may also include a gas-filled arc light such as a halogen source, semiconductor light emitting devices, light emitting chips such as a light-emitting diode (LED), a solid-state LED, an LED array or a fluorescent light source, all of which are merely exemplary. Other types of light generation devices, including lasers and X-ray sources are possible within the scope of the invention.

A fan 324 located in the lamp head housing 104 in proximity to the heat sink 320 and ballast/base 322 further acts to keep the source 300 and lamp subassembly 130 cool. The heat sink may be made of any material that has good thermal conductivity, including metal blocks of copper, aluminum or similar. In another embodiment, the cooling system includes heat pipes. In another embodiment, the cooling system includes phase change materials, some embodiments and material are exemplified as is described in U.S. application Ser. No. 11/173,274, filed on Jul. 2, 2004, entitled “Dental Light Devices Having an Improved Heat Sink”; and U.S. Provisional Application No. 60/585,224, entitled “Dental Light Devices With Phase Change Material Filled Heat Sink, the contents of which are incorporated herein by reference.

Heat sinks having a phase change material may more efficiently remove or divert heat from a light source or sources with a given weight of heat sink material when compared to a heat sink made of a solid block of thermally conductive material such as metal. Such a heat sink may even efficiently remove or divert heat from a curing light device when a reduced weight of the material is used. Using a phase change material enclosed inside a hollow thermally conductive material such as a metal heat sink instead of a conventional solid metal heat sink can decrease the weight of the curing light and increase the time the heat sink takes to reach the “shut off” temperature, as it is called in the dental curing light industry. The period prior to reaching the shut off temperature is called the “run time”. Increasing the “run time”, i.e., the time that the light can remain on, increases the time when a dentist can perform the curing or whitening procedure.

In one embodiment, a rechargeable dental curing light including at least one phase change material is disclosed. In another embodiment, a dental whitening light including at least one phase change material is disclosed. The heat sink includes a block of thermally conductive material, such as metal, having a bore or void space which is at least partially filled with a phase change material. The curing light may be adapted for therapeutic treatment by means of filters and/or diffusers.

The inventive heat sink may be installed into the dental curing light, imaging or whitening light source in the same manner a conventional metal block heat sink is installed, such as by attaching it to the heat generating source, i.e., the light source, which may include any of the ones mentioned above or combinations thereof, or by attaching it to another heat sink.

Suitable phase change material may include organic materials, inorganic materials and combinations thereof. These materials can undergo substantially reversible phase changes, and can typically go through a large, if not an infinite number of cycles without losing their effectiveness. Organic phase change materials include paraffin waxes, 2,2-dimethyl-n-docosane (C₂₄H₅₀), trimyristin, ((C₁₃H₂₇COO)₃C₃H₃), and 1,3-methyl pentacosane (C₂₆H₅₄). Inorganic materials such as hydrated salts including sodium hydrogen phosphate dodecahydrate (Na₂HPO₄.12H₂O), sodium sulfate decahydrate (Na₂SO₄.10H₂O), ferric chloride hexahydrate (FeCl₃.6H₂O), and TH29 (a hydrated salt having a melting temperature of 29° C., available from TEAP Energy of Wangara, Australia) or metallic alloys, such as Ostalloy 117 or UM47 (available from Umicore Electro-Optic Materials) are also contemplated. Exemplary materials are solids at ambient temperature, having melting points between about 30° C. and about 50° C., more for example, between about 35° C. and about 45° C. Also, the exemplary materials have a high specific heat, for example, at least about 1.7, more for example, at least about 1.9, when they are in the state at ambient temperature. In addition, the phase change materials may, for example, have a specific heat of at least about 1.5, more for example, at least about 1.6, when they are in the state at the elevated temperatures.

The phase change material may also have a high latent heat of fusion for storing significant amounts of heat energy. This latent heat of fusion may be, for example, at least about 30 kJ/kg, more for example, at least about 200 kJ/kg.

Thermal conductivity of the materials is a factor in determining the rate of heat transfer from the thermally conductive casing to the phase change material and vice versa. The thermal conductivity of the phase change material may be, for example, at least about 0.5 W/m° C. in the state at ambient temperature and at least about 0.45 W/m° C. in the state at elevated temperature.

In general, the phase change material may be contained inside a thermally conductive material such as a metal casing, The casing defines a bore, which may be of any shape, but is for example generally of cylindrical or rectangular shape. The metal casing or wall of the bore acts to contain the phase change material, and to also aid in conducting heat to and away from the phase change material. The thinner the wall, the more phase change material can be present in a given size of the heat sink, and the less it contributes to the weight of, for example, the curing light. However, the thinner the wall, the less efficient the heat sink maybe in conducting heat away from the phase change material and the longer it will take to return the phase change material to ambient temperature and its original state, so that it may function as a heat sink again. For example, the wall thickness ranges from about 1 mm to about 1.5 mm.

In one embodiment, a dental light system includes a built-in electronic voice alerting system to alert the dental professional of the completion of a dental procedure. Examples may be found in U.S. patent application Ser. No. 11/175,693, filed Jul. 5, 2005, the entire contents of which are herein incorporated by reference.

FIG. 4 shows, in perspective view, a grill 160 for a lamp head housing according to one embodiment of the invention. In the illustrated embodiment, the grill includes a plurality of perforations 131 between inner and outer surfaces thereof. The perforations 131 are adapted to permit the passage of ambient air between an interior region and an exterior region of the lamp head housing, and thus allow for cooling and ventilation of the housing. In one embodiment, the perforations include a plurality of substantially circular holes. In other embodiments, the grill may include square holes, rectangular holes or slots, louvers, or another appropriate perforated barrier such as, for example, a woven wire screen or appropriate textile material. The details of this embodiment can also be found in U.S. patent application Ser. No. 11/173,839, entitled “Illumination Systems for Dentistry Applications”, the content of which is hereby incorporated by reference.

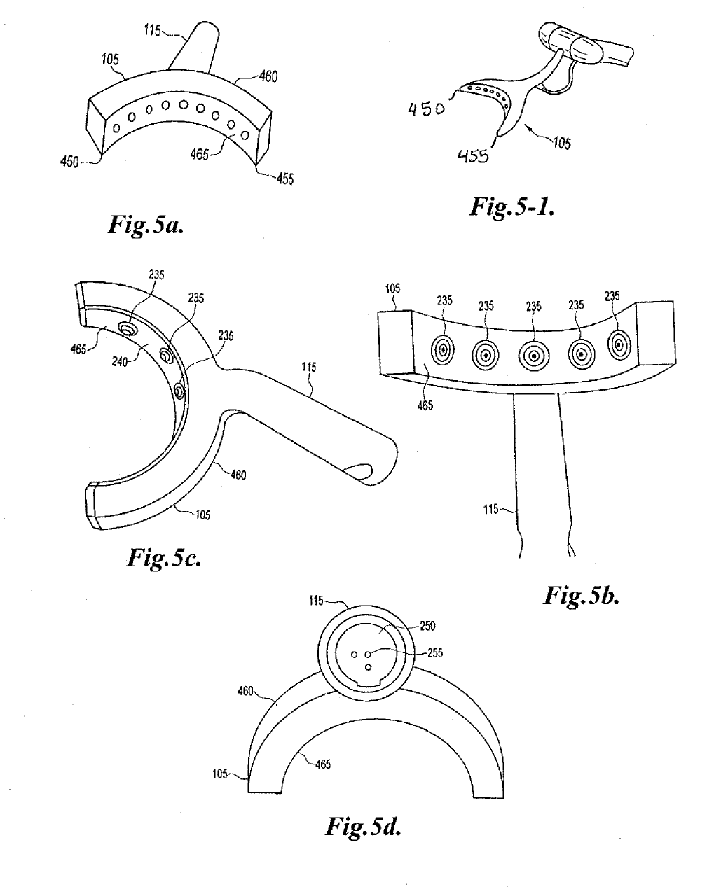

Multiple light sources, as shown in FIG. 5, may be used in place of the above lamp head housing as a self-contained structure, for example, an illumination frame, 105, in one embodiment. In another arrangement, the lamp head provides power to the illumination frame 105. The dental illumination system 100′ includes an illumination frame 105 connected to a lamp head 110′ by a tube 115. The illumination frame 105 provides light to activate a whitening substance or curing composite applied to a patient's teeth 120. The patient typically wears a reference device, such as a lip retracting device 350. The illumination frame 105 and lamp head 110′ together generate and direct light toward the patient's teeth 120′ for a whitening or a curing process. In one alternative embodiment, the illumination frame 105 and tube 115 may be adjustable with respect to the lamp head 110′. In another alternative embodiment, the tube 115 is flexible and may be adjusted to various positions. In another embodiment, the illumination frame 110′ is flexible. The details of this embodiment may also be found in U.S. patent application Ser. No. 11/173,839, entitled “Illumination Systems for Dentistry Applications”, the content of which is hereby incorporated by reference.

In the illumination system with multiple light sources, the light sources may be collectively powered or individually powered. If individually powered, each of the individual light sources may be turned on or off separately, as desired. This is especially useful for a curing or imaging process, where only one or two teeth may be undergoing treatment or being examined.

The illumination frame 105 has a first end 450 and a second end 455, which may be tapered, as shown in FIG. 5-1, to reduce the bulk of the side of the illumination frame 105 at the patient's mouth.

In one embodiment, the illumination frame 105 has a plurality of light sources 235 that are substantially evenly spaced across the surface of the front of the illumination frame 465, as exemplified in FIG. 5a. Other embodiments of the invention have different arrangements of light sources 235 across the front 465. For example, instead of being evenly spaced, the light sources may be staggered. The present invention is not limited to the number and arrangement of light sources 235 shown here.

In FIG. 5b, the illumination frame 105 has a front 465 and a back 460. A tube 115 is connected to the back 460 and a plurality of light sources 235 are arranged along the front 225 of the illumination frame 105. In the embodiment shown, the surface 240 of the front 225 of the illumination frame 105 is non-reflective. In a first embodiment, the surface 240 is a non-reflective coating. In a second embodiment, the surface 240 is a layer of material such as a non-reflective plastic or rubber.

FIG. 5c is a rear perspective view of an illumination frame according to one embodiment of the invention. The illumination frame 105 also has a front 225 and a back 460 with a tube 115 attached to the back 460. The tube 115 provides support for the illumination frame 105 and also carries electrical wiring for the light sources (not shown). The wiring (not shown) is connected to an electrical connector 255 located at the inside 250 of the tube 115.

In another embodiment, as shown in FIG. 5d, the illumination frame 105 has a generally rectangular shape and a substantially flat front surface 500 with a plurality of light sources 505 arranged along the front side 500. FIG. 5e is a perspective view of an alternative arrangement of the illumination frame of FIG. 5d. The illumination frame 105 has a first slotted structure 520 on one end and a second slotted structure 525 on the other end. Each slotted structure 520, 525 is disposed forwardly from the front side 500 of the illumination frame 105. The slots 530, 535 in each slotted structure 520, 525 begin at respective front ends 540, 545 of the slotted structures 520, 525 and are disposed inwardly toward the front surface 500 of the illumination frame 105, and are configured and arranged to mate with the formations, such as wing-like members, of a reference device, such as a lip retracting device 350.

In other embodiments of the invention, the illumination frame 105 may be shaped and configured to mate with a reference device such as a lip retracting device worn by the patient, thereby providing a substantially precise alignment with the patient's mouth.

FIG. 5f is a top view of an illumination frame 105 including a heat sink according to one embodiment of the invention. The illumination frame 105 has a plurality of light sources 235, having a heat sink 650 coupled to their ballasts (or, base). The heat sink 650 may be made of any material as mentioned above, including a phase change material. The heat sink may also be of any shape.

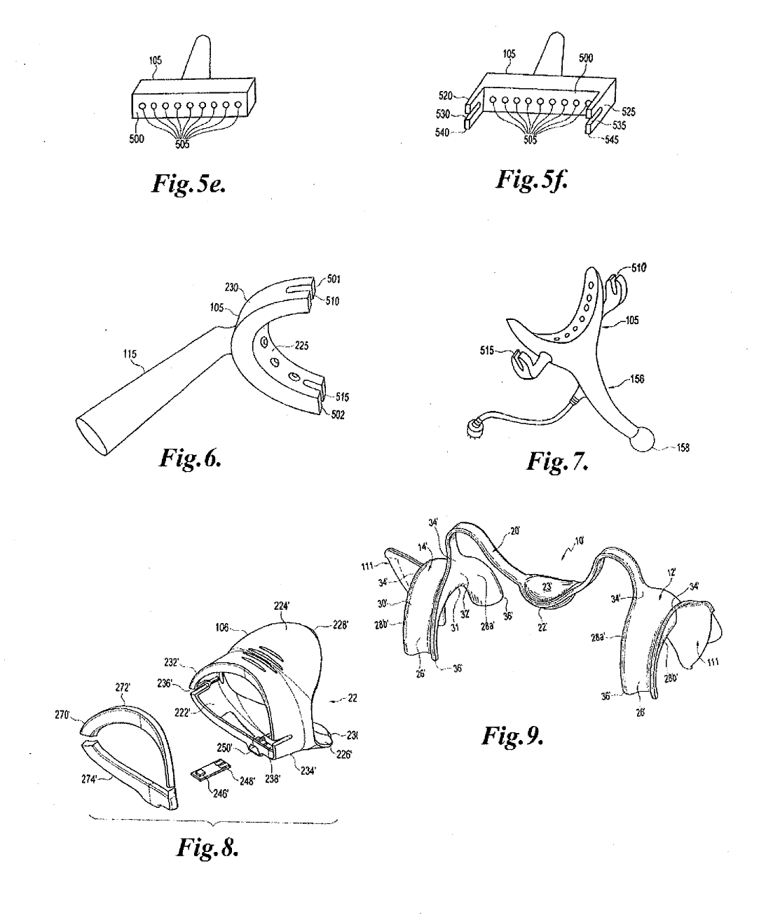

In another aspect, the illumination frame 105 may be a self-contained structure, such as shown in FIGS. 5, 6 and 7. In FIG. 6, the illumination frame 105 has a generally arcuate shape having a first end 501 and a second end 502. The back 230 of the illumination frame 105 is convex and the front 225 of the illumination frame 105 is concave. The illumination frame 105 may also serve as the spacer having formations. In other words, the spacer and formations, for example, slots, may both be present on the lamp housing, such as the illumination frame 105. The ends 500, 505 each has a slot 510, 515 open from the front 225 of the illumination frame 105 towards the back 230 of the illumination frame 105. Each slot 510, 515, extends inwardly from its respective end 501, 502 of the illumination frame 105. The slots 510, 515 are located and configured to mate with the formations of a reference device, such as the wings 111 of a lip retracting device 1138, as shown in FIG. 9.

The light sources of the illumination frame 105 may be of one wavelength, or may be of different wavelengths, as mentioned above. The wavelengths may vary depending on the dental procedure desired. In one embodiment, for therapeutic treatment, the wavelengths may be, for example, range from about 350 nm to about 700 nm, more for example, from about 380 nm to about 520 nm, even more for example, from about 400 nm to about 505 nm., and still even more example, from about 430 nm to about 510 nm.

FIG. 8 shows another embodiment of the light guide 106 of a generally ellipsoidal shape having a first opening 220′ at one end that attaches to the lamp head housing 104 and a second opening 222′ at the other end that interfaces with the patient. The first opening 220′ has extended edges 224′, 226′ that extend substantially parallel to the long diameter of the oval formed by the light guide 106.

The extended edges 224′, 226′ form a curved interface configured to mate with the lamp head housing 104. The light guide 106 mechanically couples to the lamp head housing 104. A first protrusion 228′ on extended edge 224′ and a second protrusion 230′ on extended edge 226′ are configured to mate with indentations on the lamp head 102 and act to hold the light guide 106 to the lamp head housing 104. A first slot 236′ and a second slot 238′ on opposing sides of the second opening 222′ of the light guide 106 may be configured to mate with a reference device, such as a lip retracting device 1148, worn by the patient as illustrated in FIG. 9 described below to align the lamp head 102 accurately with the patient.

In one embodiment, an elastic protector 270 is mounted around the second opening 222′ of the light guide 106 to provide a soft interface between the light guide 106 and the patient. The elastic protector 270 may be made of any open-cell or closed-cell foam, rubber or elastomer, such as described above for the soft overlays, and is attached to the light guide 106 by means of heat sealing or an adhesive. In some embodiments, the elastic protector 270 may be present in pieces 272, 274, which may again be attached to the light guide 106 by means of heat sealing or an adhesive. Suitable adhesives may include, but are not limited to, structure adhesives, hot melt adhesives, pressure-sensitive adhesives, reactive adhesives or the like. Alternatively, suitable adhesives may be acrylic-based, polyurethane-based, epoxy-based, polyamide-based, styrene copolymer-based, polyolefin-based or similar. Further, the elastic protector pieces 272, 274 may also be integrally molded onto the light guide 106.

In the present embodiment, the elastic protector 270 is made in two pieces, an upper portion 272 and a lower portion 274, extending the slots 236′, 238′ of the light guide 106 so as to accommodate the wing-like members of an exemplary lip retracting device.

According to one embodiment of the invention, a light guide 106, such as that exemplified in FIG. 8, is intended to be a single-use item, used for one patient, or one time dental whitening treatment, filling procedure, or imaging, and then discarded. With this in mind, in the illustrated embodiment of FIG. 8, the light guide 106 further includes a memory integrated circuit 246′ disposed within a space 250′ molded into the underside of the light guide 106. The memory integrated circuit 246′ stores a record of a duration of use signal indicating how long the particular light guide has been in use. The light guide memory integrated circuit 246′ is part of a system for ensuring that the light guide 106 is not improperly reused.

The biocompostable or biodegradable polymers, including those mentioned above, are particularly suited for single use light guides.

In operation, the light guide 106 is attached to the lamp head housing 104. The light guide 106 has both a mechanical attachment mechanism (the slots 228′, 230′) as described above and an electrical contact 248 between the light guide memory integrated circuit 246′ and electronics in the lamp head housing 104. The electrical contact 248′ mates with a conductive projection in the lamp head forming an electro-mechanical connection that enables signaling between the light guide memory integrated circuit 246′ and electronics in the lamp head housing 104.

The light guide 106 is aligned with the patient's mouth using the positionability of the lamp system 100 and whitening treatment is administered. A signaling device within lamp head 102, or within the power pack, records duration of use of light guide usage onto the memory integrated circuit 246′. When a light guide usage limit is reached, the lamp system 100 precludes activation of the light source 300 in the lamp head housing 104 and the light guide 106 is replaced in order to operate the lamp system 100.

In an alternative embodiment of the light guide 106, no elastic protector 270 is used to interface between the light guide 106 and the patient. In further alternative embodiments of the light guide 106, the contact between the light guide memory integrated circuit 246′ and electronics in the lamp head 102 is a magnetic contact. Alternatively, the memory integrated circuit 246′ may communicate with the lamp head 102 through infrared radiation or through wireless radio signals or through light from the visible portion of the electromagnetic spectrum.

The structure of a light guide may include a UV-inhibiting material in order to protect the patient's skin from ultra-violet light exposure. The light guide may be made of similar of material as that of the lamp housing 104 and lamp head 102 as described above. Additionally, like the lamp housing 104 and the lamp head 102, a liquid crystal polymer, one that reflects rather than transmits light energy, may be used, either as a coating or as the main ingredient of the light guide to minimize escape of light energy.

Referring now to FIG. 9, there is shown an embodiment of a lip retracting device 10′ for retracting the lips for facilitating examination of the mouth and/or teeth, the whitening or curing process. The device includes two spaced apart channel retainers 12′, 14′, also known as flanges, for retaining two corresponding portions of the lips for examination and/or treatment of the mouth or teeth. When used, the lip retracting device 10′ draws back the lips, which retracts the cheeks, to expose the mouth so that a health care professional can more easily see the teeth and work on the teeth and/or mouth.

The two channel retainers 12′, 14′ are for retaining the ends of the lips, approximately where the upper and the lower lips intersect. More particularly, the two channel retainers or flanges 12′, 14′ are adapted to cup the lips and bias them in the open position to expose the teeth for treatment and/or examination.

A resilient member 20′ is incorporated in the lip retracting device 10′ to interconnect the two channel retainers 12′, 14′ together and to function as biasing means. The resilient member 20′ has two arches, one on either side of the center portion 22′. The resilient member 20′ may be formed as a single piece integrally molded or attached to the inside side walls 28a′ of the channel retainers 12′, 14′, or it may be formed in two halves separately connected to the mid-portion 22′, also integrally molded or attached to the inside side wall 28a′ of the channel retainers 12′, 14′. In the ready position (before insertion of the lip retracting device into the mouth), the resilient members 20′ are arched outwardly with respect to the center portion of the lip retracting device 10′. As further discussed below, when the lip retracting device 10′ is inserted into the mouth and the two channel retainers 12′, 14′ cup respective portions of the lips, the resilient members 20′ provide a retractive force to radially retract the lips outward for examination and/or treatment. This lip retracting device is especially useful for the whitening process.

Pads may be provided with the resilient member 20′ to provide comfort for the patient when the patient is fitted with the lip retracting device 10′. The pads 107 may be positioned on the resilient member 20′, as shown in FIG. 11.

An optional tongue retainer 22′ can also be approximately centrally positioned relative to the two channel retainers 12′, 14′. The tongue retainer 22′ of the present embodiment may also include a trough 23′. Further, it may be integrally formed on the mid-portion of the resilient member 20′ and thus be attached to the channel retainers 12′, 14′ via resilient member 20′. When incorporated, the tongue retainer blocks the tongue and limits the tongue to the back vicinity of the mouth, thus enabling access to the lingual portion or back of the teeth for examination and/or treatment. In short, the tongue retainer is configured to minimize interference by the tongue during treatment and/or examination by a health care professional. In this embodiment, the resilient member 20′ acts not only to connect the channel retainers and to bias them, but also to connect the tongue retainer to the channel retainers. If the tongue retainer 22′ is not incorporated, the resilient member 20′ would simply extend from one channel retainer 12′ to another channel retainer 14′ at a substantially uniform width.

The channel retainers 12′, 14′ resemble a curvilinear c-channel in that they include an arcuate race 26′ and two channel side walls 28a′, 28b′. The channel side walls 28a′, 28b′ resemble a bell shape and include a maximum wall dimension at approximately the mid-point 34′ and two smaller tapered tips 36′ at the ends thereof. In one embodiment, the inside side wall 28a′, which is intraoral, as further discussed below, is slightly larger relative to the outside side wall 28b′. However, the relative dimensions may be reversed or may be the same without deviating from the functionality of the lip retracting device 10′.

The side channel retainers 12′, 14′ further include an interior surface 30′ and an exterior surface 32′. The arcuate race 26′ comprises a radius of curvature 31′ adapted to mimic the curvature of the side of the lips when the lips are in the opened position. Similarly, because this curvature may vary depending on the size and age of the user or patient, the lip retracting device 10′ may be implemented with varying radii of curvatures 31′ to fit the varied shape of the particular user/patient. The arcuate race 26′ may also include an irregular curvature or two or more different radii of curvatures. For example, the lower region 38′ of the radius of curvature 31′ may have a larger radius than the upper region 40′ or vice versa. If implemented, the irregular curvature may vary the amount of retraction of the portion of the lip that is seated within the arcuate race to vary the amount of retraction between those portions of the lip.

The lip retracting device 10′ may also be made by injection molding or casting a thermoplastic material such as those already mentioned. For example, the lip retracting device 10′ may be made by injection molding pigmented polypropylene and is opaque white or colored having a smooth finish.

Additionally, FIG. 9 also shows two formations in the shape of wing-like flanges 111 extending from the outside side wall 28b′ of the channel retainers 12′, 14′. The wing-like flanges 111 may be molded or cast integrally with the channel flanges or retainers 12′, 14′. As further discussed below, the wing-like flanges are designed for fitting the lip retracting device 10′ to the slots formed on a cone section of an output port or light guide of a lamp source used in a teeth whitening process, or to the slots in any examining device.

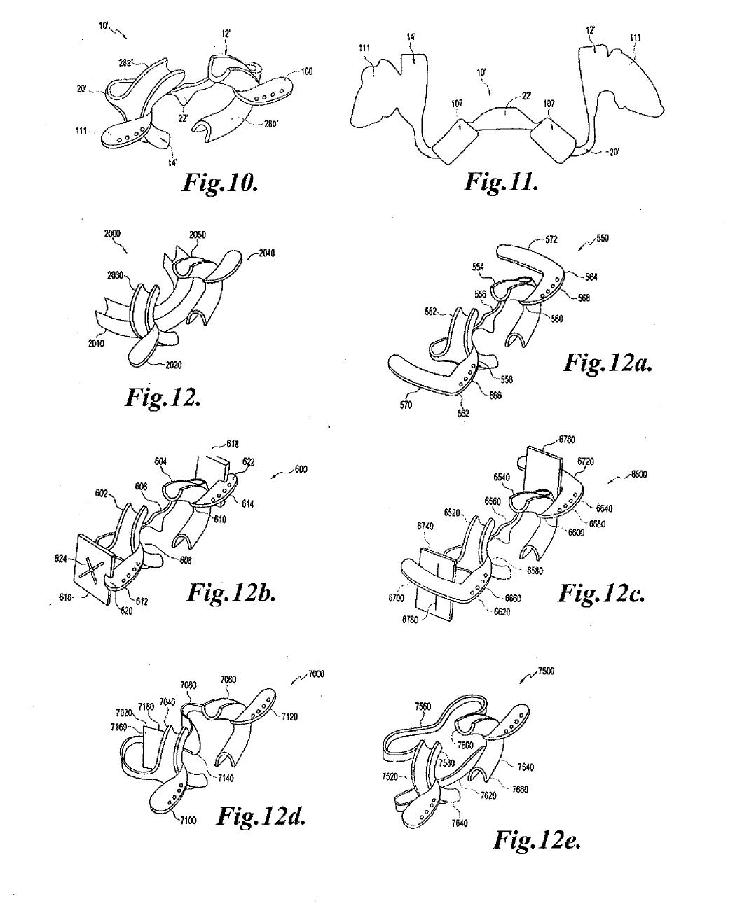

The lip retracting device 10′ is configured to fit into the mouth in the orientation shown in FIG. 10. In other words, in FIG. 10, the inside side walls 28a′, and the tongue retractor 22′ are configured to be intraoral while the outside side walls 28b′, the resilient member 20′ and the wing-like members 111 are configured to be extraoral.

According to one embodiment of the invention, a pair of interface wings 111 is coupled to the “U”-shaped channels 355, 360 respectively. According to one embodiment of the invention, the interface wings 111 each include a respective upper surface 390, 395 and a respective lower surface 401, 403. According to one embodiment of the invention, upper surface 390 is disposed substantially parallel in relation to lower surface 401 and upper surface 395 is disposed substantially parallel in relation to lower surface 403. Pursuant to one embodiment of the invention, the interface wings 111 have a first plurality of ticks or holes 413 and a second plurality of ticks or holes 415 respectively. The ticks or holes are adapted to facilitate maintaining a particular alignment of, for example, an illumination frame (as shown in FIG. 6) 105 with respect to the lip retracting device 350.

According to one embodiment of the invention, interface wings 111 are adapted to be received within slots 236′, 238′ of a light guide 106, as shown in, for example, FIG. 8, respectively. By pressing the lip retracting device 350 toward the front edge of light guide 106, the interface wings 111 are urged into slots 236′ and 238′, whereby the orientation and position of the lip retracting device 350 with respect to the light guide 106 is substantially fixed. Consequently, to the extent that a patient's lips effectively serve to couple the head and teeth of the patient in fixed relation to the lip retracting device 350, a target tooth is maintained in substantially fixed position with respect to a light source disposed within a lamp-head as shown, for example in FIG. 2.

FIG. 12 shows another embodiment of a lip retracting device 2000 of the present invention. The lip retracting device 2000 includes a first u-shaped channel 2010 shaped and configured to accommodate a lower, or alternatively an upper, set of a patient's teeth (not shown). The lip retracting device 2000 further includes a second u-shaped channel 2030 and a third u-shaped channel 2050 mounted substantially perpendicular to the first u-shaped channel 2010. The second and third u-shaped channels 2030, 2050 are adapted to receive the lips of the dental patient. The first u-shaped channel 2010 supports the second and third u-shaped channels 2030, 2050 in substantially fixed spatial relation with respect to one another.

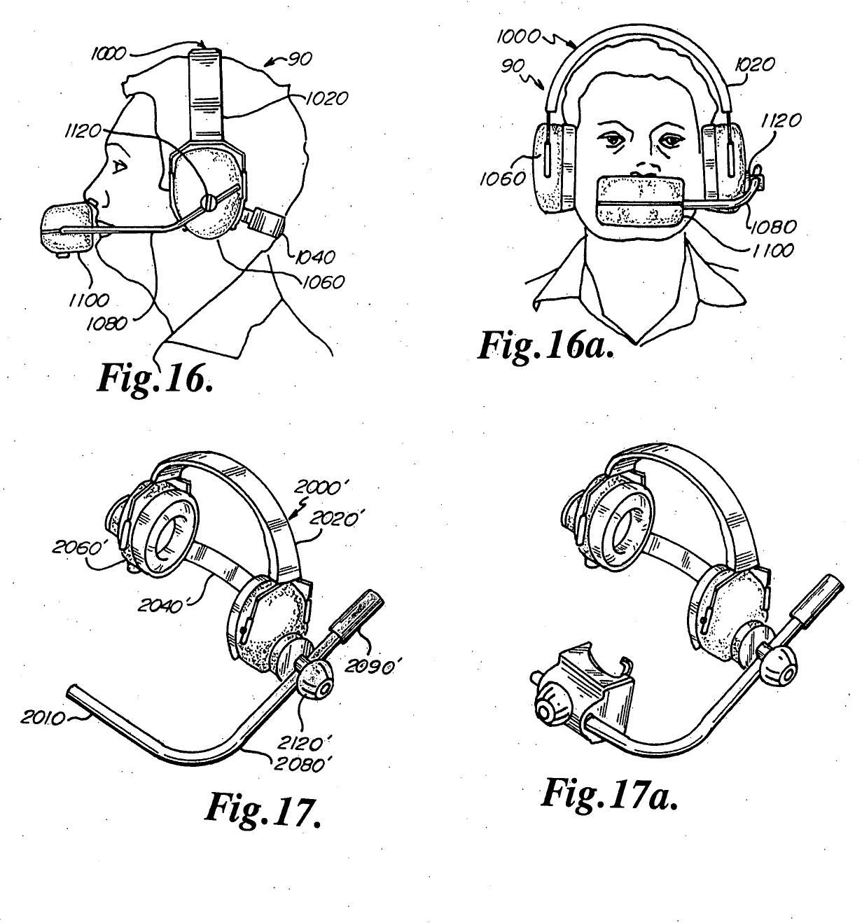

According to the present embodiment of the invention, a pair of interface wings 2020, 2040 is coupled to the second and the third u-shaped channels 2030, 2050 respectively. The interface wings 2020, 2040 are shaped and configured to be received into slots 1130, 1132 in a light guide 1104, fitted to a lamp head or light source 1102, as shown in FIG. 15, in order to align the light source 1102 with the teeth of a patient. To the extent that a patient's lips effectively serve to couple a lamp head and teeth of the patient in fixed relation to the lip retracting device 1138, the lip retracting device 1138 is maintained in a substantially fixed position with respect to a light source disposed within a lamp-head as shown, for example in FIG. 15. This is described in greater detail below.

The interface wings or wing-like members, 2020, 2040, like the wing-like members of the above described lip retracting devices, typically have some rigidity so that the interface wings 2020, 2040 may form an effective interface when mated with the slots 1130, 1132 of the light guide 1104, as seen in FIG. 15. Similar to the embodiments described above, the interface wings 2020, 2040 may in a first arrangement be formed of the same material as the channels 2010, 2030, 2050. In a second arrangement, the interface wings 2020, 2040 are made of a different material from the channels 2010, 2030, 2050.

FIG. 12a shows a lip retracting device 550 according to an alternative embodiment of the invention. The lip retracting device 550 has a first u-shaped channel 552 and a second u-shaped channel 554 to hold the lips of the patient whose teeth are to be imaged. A support member 556 is mutually coupled to the u-shaped channels 552, 554 and is adapted to support the u-shaped channels 552, 554 in substantially fixed spatial relation with respect to one another. A first end 558 of the first interface wing 562 is coupled to the first u-shaped channel 552. A first end 560 of the second interface wing 564 is coupled to the second u-shaped channel 554.

Each interface wing 562, 564 includes a first portion 566, 568 located at the front of the lip retracting device 550 away from the patient. A second portion 570, 572 of each interface wing 562, 564 extends outward and toward the back of the lip retracting device 550. In operation, the first portions 566, 568 are located at the front of the patient's face while each second portion 570, 572 is located at a side of the patient's face. The interface wings 562, 564 are adapted to be received within the slots 236, 238 of the beam guide 106. The first portions 566, 568 enable the beam guide 106 to be aligned to the front of the patient. The second portions 570, 572 of the interface wings 562, 564 enable the beam guide 106 and imaging head 102 to be aligned on either side of the patient's head.

FIG. 12b shows a lip retracting device 600 according to an alternative embodiment of the invention. The lip retracting device 600 has a first u-shaped channel 602 and a second u-shaped channel 604 to hold the lips of the patient whose teeth are to be imaged. A support member 606 is mutually coupled to the u-shaped channels 602, 604 and is adapted to support the u-shaped channels 602, 604 in substantially fixed spatial relation with respect to one another. A first end 608 of the first interface wing 612 is coupled to the first u-shaped channel 602. A first end 610 of the second interface wing 614 is coupled to the second u-shaped channel 604. The interface wings 612, 614 are adapted to be received within the slots 236, 238 respectively of the beam guide 106. A target 616, 618 is coupled to a second end 620, 622 of the first interface wing 612 and second interface wing 614 respectively. Each target 616, 618 has alignment markings 624. In operation, the targets 616, 618 act as visual alignment mechanisms for the imaging head 102 for side images of the patient's teeth.

FIG. 12c shows a lip retracting device 6500 according to an alternative embodiment of the invention. The lip retracting device 6500 has a first u-shaped channel 6520 and a second u-shaped channel 6540 to hold the lips of the patient whose teeth are to be imaged. A support member 6560 is mutually coupled to the u-shaped channels 6520, 6540 and is adapted to support the u-shaped channels 6520, 6540 in substantially fixed spatial relation with respect to one another.

A first end 658 of the first interface wing 6620 is coupled to the first u-shaped channel 6520. A first end 6600 of the second interface wing 664 is coupled to the second u-shaped channel 6540. Each interface wing 6620, 6640 includes a first portion 6660, 6680 located at the front of the lip retracting device 6500 away from the patient. A second portion 5700, 5720 of each interface wing 6620, 6640 extends outward and toward the back of the lip retracting device 6500. In operation, the first portions 6660, 6680 are located at the front of the patient's face while each second portion 6700, 6720 is located at a side of the patient's face. The interface wings 6620, 6640 are adapted to be received within the slots 236, 238 of the beam guide 106. The first portions 6660, 6680 enable the beam guide 106 to be aligned to the front of the patient. The second portions 6700, 6720 of the interface wings 6620, 6640 enable the beam guide 106 and imaging head 102 to be aligned on either side of the patient's head.

A target 6740, 6760 is coupled to the second portions 6700, 6720 of the first interface wing 6620 and second interface wing 6640 respectively. Each target 6740, 6760 has visual alignment markings 6780. In operation, the targets 6740, 6760 act as visual alignment mechanisms for the imaging head 102 for side images of the patient.

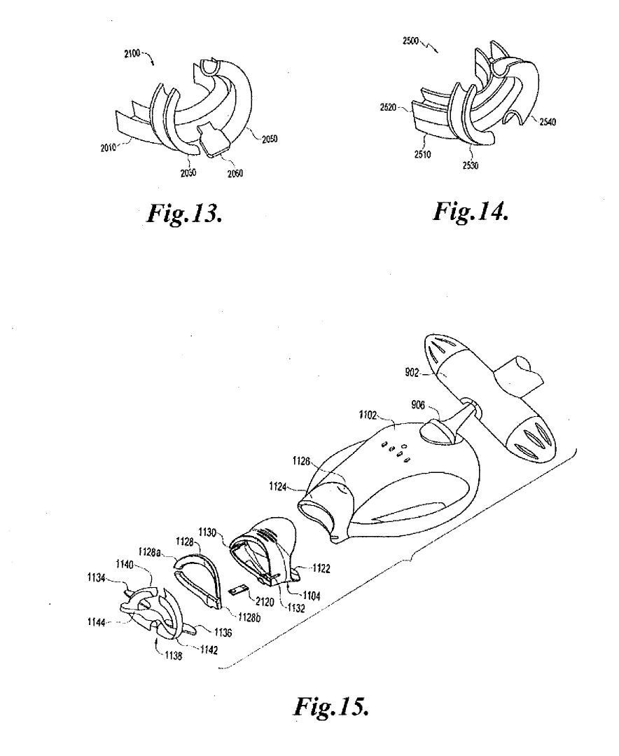

FIG. 13 shows a lip retracting device 2100 having a first u-shaped channel 2010 mutually coupled to a second u-shaped channel 2030 and third u-shaped channel 2050 which are substantially perpendicular to the first u-shaped channel 2010. A tab 2060 is coupled to the first u-shaped channel 2010 between the second and third u-shaped channels 2030, 2050. The tab 2060 is useful for positioning the lip retracting device 2100 in the mouth of the dental patient. Later, after completion of the whitening process, the tab 2060 is useful for removing the lip retracting device 2100 from the mouth of the dental patient.

FIG. 14 is an alternative embodiment of the lip retracting device according to principles of the invention. The lip retracting device 2500 includes a lower jaw u-shaped channel 2510 and an upper jaw u-shaped channel 2520. The lower jaw u-shaped channel 2510 is shaped and configured to accommodate the lower set of the patient's teeth (not shown) while the upper jaw u-shaped channel 2520 is shaped and configured to accommodate the upper set of the patient teeth (not shown). Both the lower jaw u-shaped channel 2510 and the upper jaw u-shaped channel 2520 are adapted to receive a treatment composition, such as a whitening composition. The lip retracting device 2500 further includes a first u-shaped lip retracting device channel 2530 and a second u-shaped lip retracting device channel 2540. The first and second u-shaped lip retracting device channels 2530, 2540 are mounted substantially perpendicular to the lower jaw u-shaped channel 2510 and upper jaw u-shaped channel 2520. The lower jaw u-shaped channel 2510 and upper jaw u-shaped channel 2520 support the a first u-shaped lip retracting device channel 2530 and a second u-shaped lip retracting device channel 2540 in substantially fixed spatial relation with respect to one another. The first and second u-shaped lip retracting device channels 2530, 2540 are shaped and configured to receive the lips of the dental patient.

In operation, the lower jaw u-shaped channel 2510 and the upper jaw u-shaped channel 2520 receive a whitening composition. The lower jaw u-shaped channel 2510 and the upper jaw u-channel shaped 2520 are then fitted over a patient's teeth so that the treatment composition such as a whitening composition is in contact with the patient's teeth. The patient's lips are received into the first and second u-shaped lip retracting device channels 2530, 2540. Using the dental lip retracting device of the present embodiment, a dental process such as a whitening process may be performed on the lower teeth and the upper teeth at the same time effectively reducing the overall duration of the session.

FIG. 15 shows an assembly relationship between the ball joint 902 the lamp head 1102, a light guide 1104, and a lip retracting device 1138 according to one embodiment of the invention. The ball joint allows the lamp head to be swiveled in space such that an optical axis of the curing lamp is aligned with the target teeth of a dental whitening subject.

A light guide 1104 is adapted to be coupled to an anterior end of the lamp head 1102. In one embodiment, the light guide 1104 includes an inner surface region 1122 that is adapted to be held in proximity to an outer surface region 1124 of the lamp head 1102. According to one embodiment of the invention, a projecting member, or bump, on inner surface 1122 is adapted to be urged into a recessed region 1126 of outer surface region 1124.

In one embodiment of the invention, the light guide 1104 includes an elastically compressible cushion 1128 at an anterior edge thereof. The elastically compressible cushion 1128 serves to soften an interface between a dental whitening process subject (not shown) and the light guide.

In a further aspect of the invention, as shown in the illustrated embodiment, the light guide 1104 includes first and second slots 1130 and 1132. These slots are adapted to receive projecting wings 1134, 1136 of a lip retracting device 1138 so as to stabilize a relationship between the dental whitening subject and the lamp head 1102.

The lip retracting device 1138 includes channels 1140, 1142 adapted to support the lips of a dental whitening subject during the whitening process, and an elastic member 1144. The elastic or elastomeric member 1144 is coupled to the channels 1140, 1142 and adapted to urge the channels outwardly towards the lips, so as to couple the subject undergoing the dental process to the lip retracting device.

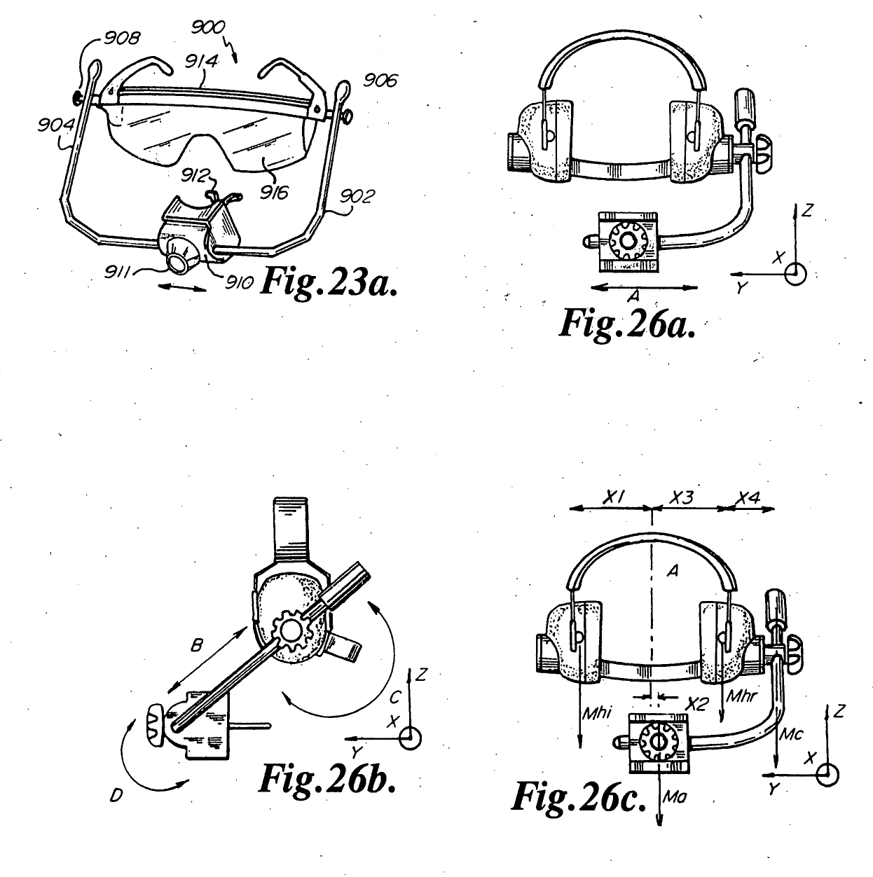

When the subject is coupled to the lip retracting device 1138, and the lip retracting device is coupled to the light guide 1104 by the insertion of wing-like members 1134, 1136 in the respective slots 1130, 1132 in the light guide 1104, the subject is spatially stabilized with respect to the lamp head 1102. In this way the support structure serves to support the lamp head in a substantially stable spatial relationship to the whitening subject. The lamp system may be supported on the patient's person by any of the support systems described below, for example, in FIGS. 16, 16a, 23 and 23a.

FIGS. 16 and 16a show a side profile view and a front view, respectively, of a dental whitening, imaging, therapeutic or curing apparatus or system 1000 according to another embodiment of the present invention. The apparatus or system 1000 includes a light or other radiation source 1100 that may be disposed in a manner such that it may aid in the action of and/or initiate the action of a whitening composition, an imaging composition, a therapeutic system or a curing compound that may be disposed on the teeth of a patient 90. The system 1000 may be secured to the head of the patient 90 by a substantially headphone-like setup having earpieces 1060 and interconnecting straps 1020, 1040. The strap 1020 may be adapted to fit comfortably but securely over the top of the head of the patient 90 while the strap 1040 may be adapted to fit behind the head. This setup may then comfortably but securely fix the apparatus 1000 to the head of the patient and at the same time allow the patient some freedom of movement while undergoing treatment without interrupting or disrupting the treatment process.

The straps 1020, 1040 may be constructed from various materials with different properties, such as, for example, those mentioned above for use in the manufacturing of the lamp head, or any semi-rigid plastic material that may allow the straps to be reversibly bent or otherwise deformed during fitting and removal. A partially elastic fit may also be used to aid in producing a tight fit of the apparatus 1000 to the head of the patient.

The earpieces 1060 may be adapted to provide both cosmetic and/or functional features to the whitening apparatus 1000. The earpieces 1060 may, for example, function substantially like standard headphone earpieces and may, as a further example, be used to play music or other audio recordings during the course of a whitening or other procedure. The earpieces 1060 may further be adapted to be comfortable for the patient to wear by, for example, including cushioning for the ears, soundproofing or sound canceling features and/or ventilation features.

The light or radiation source 1100 may be secured to the headphone-like portion of the whitening apparatus 1000 by means of an interfacing joint 1120 that may connect one of the earpieces 1060 to a positioning member 1080 at its proximal end. The positioning member 1080 may be adapted to support the light or radiation source 1100 at its distal end. The positioning member 1080 may further be bent or curved in a way conducive to positioning the light or radiation source 1100 in an optimal position in front of the patient's mouth.

The positioning member 1080 may further be adapted to swing on an axis at the interfacing joint 1120 to further aid in positioning the light or radiation source 1100 and/or to swing the light or radiation source 1100 out of the way so that the patient's mouth may be accessed. The positioning member may also include other adaptations to aid in positioning the light or radiation source 1100. In one embodiment, shown in FIG. 16b, the positioning member 1080 may include a central slot, groove or other mechanically appropriate formation 1070 that may allow the positioning member 1080 to be shifted along its long axis through joint 1120. The joint 1120 may further include features to allow reversible securing of the positioning member 1080 at any given point along the length of the central slot 1070. The positioning member 1080 may further include a handle 1090 at the proximal end to aid in positioning.

In another embodiment, as shown in FIG. 16c, the interfacing joint 1120 may include multiple features to allow different degrees of motion and/or positioning of the positioning member 1080. A perpendicular joint 1110 may be included to allow rotation of the positioning member 1080, which may further be aided by an appropriate handle 11160.

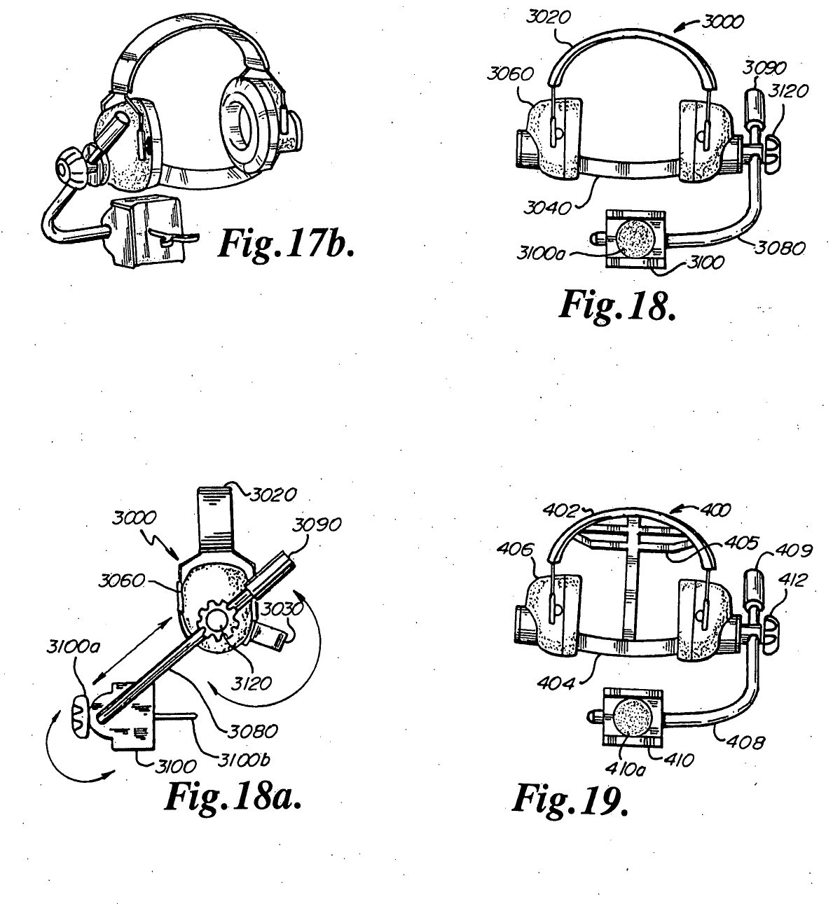

FIG. 17 shows a perspective view of a dental apparatus 2000′ in one embodiment of the present invention. The dental apparatus 2000′ is substantially identical to the whitening apparatus 1000 of FIG. 16, but does not include the light or radiation source 1100. The dental apparatus 2000′ may be adapted to mount various other apparatuses or devices at the distal end 2010′ of the positioning member 2080′. Other devices may include, but are not limited to, curing lights, ultrasonic energy sources, dental trays, lip retractors or any other appropriate device that may require fixed positioning with respect to a patient's mouth.

In some embodiments, the dental apparatus 2000′ may be equipped with a dental device such as the one seen in FIGS. 17a and 17b. The dental device may include additional features that may increase its ability to fit comfortably with a patient, as further outlined below.

FIGS. 18 and 18a show front and side profile views, respectively, of a dental apparatus 3000 in another embodiment of the present invention. The dental apparatus 3000 is substantially identical to the whitening apparatus 1000 of FIGS. 17a and 17b with a dental device 3100 attached to the positioning member 3080. The dental device 3100 may be, for example, a light or radiation source, ultrasonic energy source, dental tray, or any other appropriate device that may require fixed positioning with respect to a patient's mouth. The device 3100 may include, for example, an adjustment knob 3100a that may be adapted to allow the device 3100 to slide along the positioning member 3080 and be reversibly secured at any given point such that the position of the device 3100 may be adjusted to fit the patient. The device 3100 may further include, as shown in FIG. 18a, an extension 3100b that may fit into the mouth of the patient to aid in positioning of the device 3100 relative to the patient's mouth.

In other embodiments, the dental apparatus may include additional straps or supporting features. The dental apparatus 400, as illustrated in front and side profile in FIGS. 19 and 19a, respectively, which is substantially identical to the apparatus 300 of FIG. 18, may further include additional straps 405 that may form a cap or head harness-like formation. The additional straps 405 may serve to further secure the dental apparatus 400 to the head of the patient and may also, for example, increase the area of load distribution, which may in turn decrease the formation of pressure points on the patient's head. The increased area of contact may also serve to decrease the likelihood of the apparatus 400 shifting in position, which may result in the loss of optimal positioning of the dental device 410 with respect to the patient's mouth.

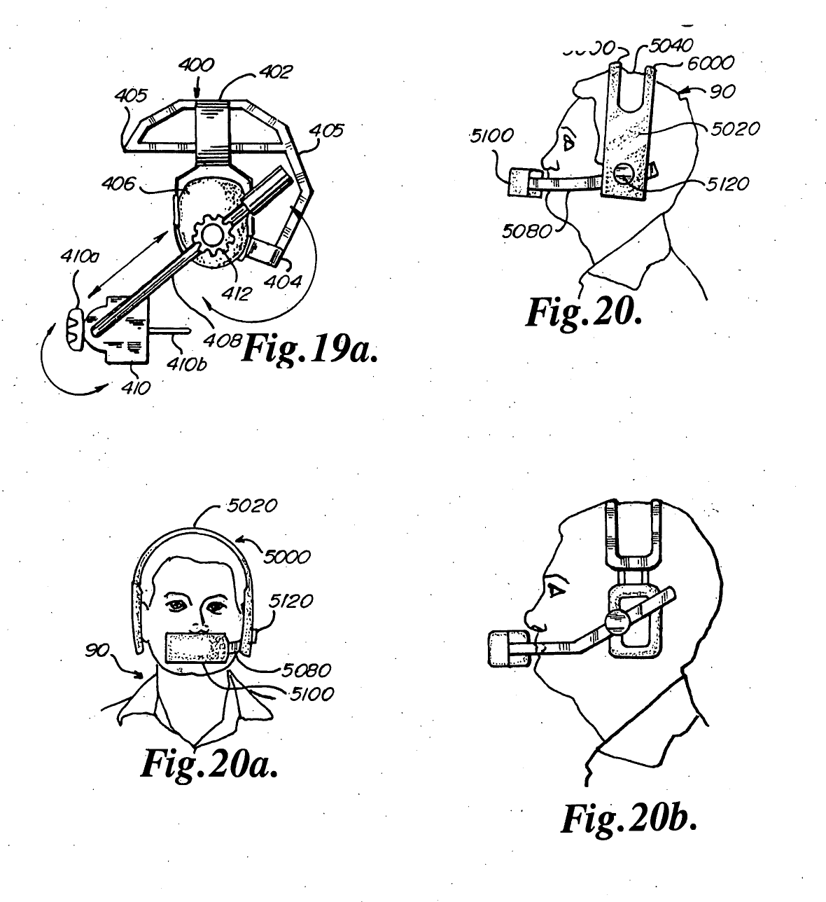

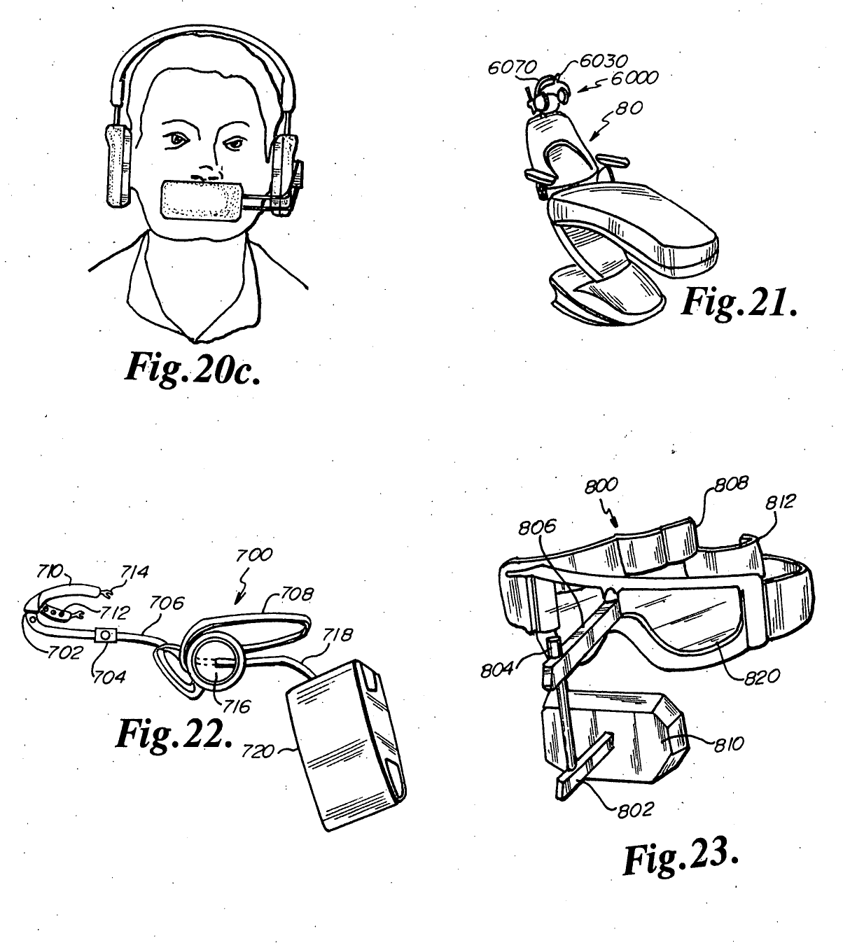

FIGS. 20 and 20a show another embodiment of a dental apparatus 5000 of the present invention in front and side profile views, respectively. The dental apparatus 5000 may serve as a simplified version of the previous embodiments that may eliminate some accessory elements, such as, for example, earpieces. The dental device 5100 may further be attached to the positioning member 5080 in a fixed manner for a one-size-fits-all configuration. The dental apparatus 5000 further includes the head strap 5020 which may operate without any additional straps as a further simplification. The head strap 5020 may further include a ventilating cutout 5040 that may serve to decrease the area of the patient's head covered by the strap, which may in turn increase the comfort for the patient. The cutout 5040 may also decrease the overall weight of the strap 5020, which may in turn increase the overall comfort of the patient and the ease of handling for a dental professional. The head strap 5020 may further be lined with a suitable cushioning material to further increase the comfort for the patient. The cushioning material may include those mentioned above for the soft overlays.

Additionally, the dental apparatus may be further modified to decrease the overall weight and increase the ventilating effect provided by a smaller amount of covering. FIGS. 20b and 20c show side profile and front views, respectively, of a further embodiment of a dental apparatus that may include additional reductions in overall covering of the patient's head, especially around the ears of the patient. The apparatus may also include wire frame support members in place of solid members that may further reduce the overall weight of the apparatus.

In still other embodiments, a dental apparatus may be mounted or otherwise attached to a dentist chair. FIG. 21 shows a perspective view of a dentist chair 80 which may include a mounted dental apparatus 6000, which may be substantially identical to any of the aforementioned embodiments. The dental apparatus 6000 may be mounted to the dentist chair 80 by a variety of methods which may include, but is not limited to, a headrest-mounted arm 6070 which may attach to a positioning member 6030. The positioning member 6030 may be adapted to adjust the vertical position of the dental apparatus 6000 with respect to the patient. The headrest-mounted arm 6070 may also be adapted to adjust the position of the dental apparatus 6000 by, for example, swinging backward to allow the patient's head clearance and forward to mount the apparatus on the patient's head. This support system may be used for any of the lamp systems described above that may help to spread the load of the lamp system and still provides some freedom of movement for the patient undergoing treatment.

FIG. 22 shows a perspective view of a dental apparatus according to yet another embodiment of the present invention. The dental apparatus 700 may include a headset 708 which may be substantially similar to wrap-around headphone designs. The headset 708 may include earpieces 716, which may be adapted to provide both cosmetic and/or functional features to the dental apparatus 700. The earpieces 716 may, for example, function substantially like standard headphone earpieces and may, as a further example, be used to play music or other audio recordings during the course of whitening or other procedure. The earpieces 716 may further be adapted to be comfortable for the patient to wear by, for example, including cushioning for the ears, soundproofing or sound canceling features and/or ventilation features.

The dental apparatus 700 may further include a dental device 710, which may be secured to the headphone-like portion of the whitening apparatus 700 by a positioning member 706. The positioning member 706 may include a joint or adjustment feature 704, which may be adapted to allow adjustment of the length of the positioning member 706 or the angle between the two halves of the positioning member 706 around the joint 704. The positioning member 706 may also include a second joint 702 to adjust the angle of the dental device 710. The dental device 710 may be, for example as illustrated, a light or radiation source. The light or radiation source 710 may employ a single or multiple (as shown) individual light or radiation sources 712. The light or radiation source 710 may further include interfacing features 714 which may be adapted to receive the wing-like portions of a lip retractor worn by a patient (not shown). This may aid in positioning the light or radiation source 710 relative to the patient's teeth.

The dental apparatus 700 may also include an external control system 720. The control system 720 may be linked by a cable 718 to the headset 708 (as shown), or it may be linked wirelessly. The control system 720 may provide electrical energy to the dental apparatus 700 and may also provide audio signals to the earpieces 716. The control system may be adapted to resemble any common piece of personal electronics such as, for example, a personal MP3 player. This may allow the patient to interact with audio stimuli provided by the dental apparatus 700 by, for example, changing a music or other audio selection during the course of a procedure.

FIG. 23 shows yet another embodiment of a dental apparatus 800 of the present invention. The goggles 820 may be adapted to protect the wearer's eyes from harmful light or radiation, such as, for example, high intensity ultraviolet light. The goggles 820 may include a strap 808 that may allow the goggles to be secured to the head of a patient. The strap 808 may also include an adjustment feature 812 that may allow the length of the strap 808 to be varied. This may allow a better or custom fit for the patient. The dental apparatus 800 may include a dental device 810 that may be attached to the goggles 820 by means of positioning member 802, adjustment member 804 and attachment member 806. Attachment member 806 may be adapted to mount onto the middle of the goggles 820. The adjustment member 804 may interface with the attachment member 806. It may further be adapted to vary the vertical position of the dental device 810. The positioning member 802 may interface with the adjustment member 804 and may be adapted to vary the distance between the dental device 810 and the patient's mouth in the horizontal plane.

In another embodiment, a dental illumination source 910 may also be mounted on other forms of eyewear or similar objects. FIG. 23a shows an example of an illumination source 910 mounted on a set of protective eyewear frame, which bear more similarity to standard eyeglasses than the embodiment shown in FIG. 23. The dental apparatus 900 may include a dental light source 910 that may be attached to the eyeglass frame 914 by means of two attachment joints 906, 908 on either side of the frame 914. Two arms 902, 904, may swing around reference points on the attachment joints 906, 908, respectively, in a manner similar to the positioning members discussed above in FIGS. 16-20. The eyeglass frame 914 may further include a protective cover 916 that may aid in shielding the patient's eyes from any potentially harmful radiation that may emanate from the dental device 910. The dental device 910 may be slidably mounted on the two joining arms 902,904 and be adjusted in the horizontal direction indicated in the figure utilizing the loosening and tightening of its position by the position knob 911.

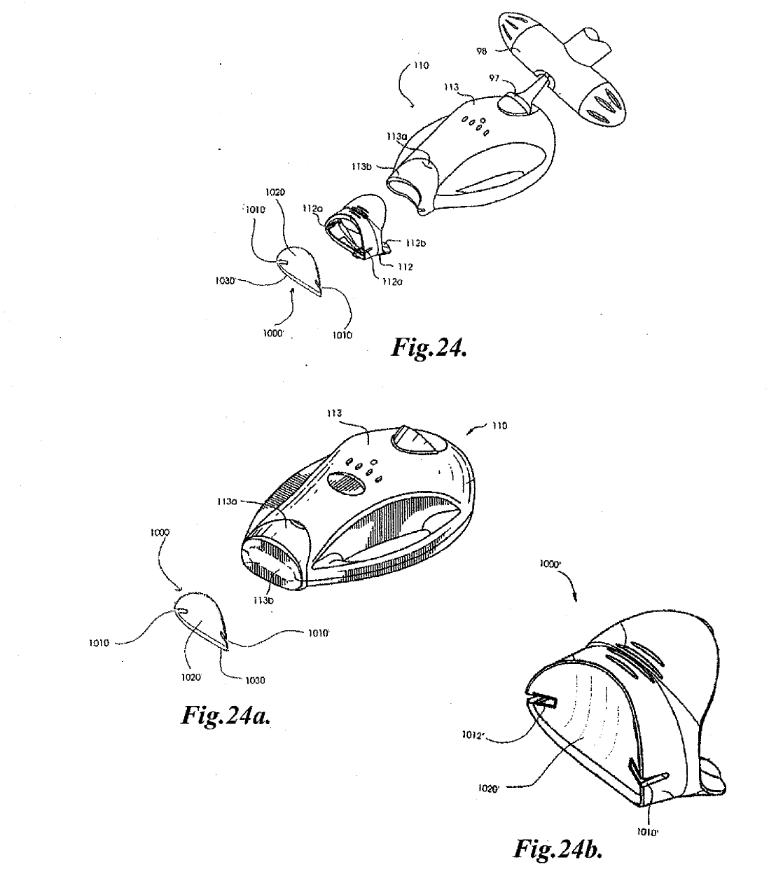

FIG. 24 shows an exploded view of a dental whitening lamp assembly 110 in an exemplary embodiment of the present invention. The dental whitening lamp assembly 110 may include an optical filter 1000′. The optical filter 1000′ may include an optical window 1020, which may be adapted to block certain wavelengths of electromagnetic radiation while allowing others to pass. In other embodiments, the optical window 1020′ may be adapted to block a certain percentage of particular wavelengths of electromagnetic radiation or of all wavelengths. The optical window 1020′ may further be adapted to perform a variety of other functions, such as, but not limited to, diffusing exiting electromagnetic radiation, reducing emitted heat from the dental whitening lamp 110, focusing exiting electromagnetic radiation, altering the wavelength of exiting electromagnetic radiation, converting electromagnetic radiation into electrical energy and/or spatially organizing emitted electromagnetic radiation.

The optical window 1020′ may be mounted in a frame 1030′, which may be adapted to allow the optical filter 1000′ to interface with a portion of the dental whitening lamp assembly 110. A mechanical interface may achieved by a variety of methods and may include, but are not limited to, magnetic attachment (which may include magnets in the frame 1030′ and the light guide 112), adhesive attachment a friction fit, and/or mechanical attachment, such as a bolt or bolts, a screw or screws, other similar attachment methods, or combinations thereof. Other attachment methods for enabling clip-on, snap-on, etc. may be used. The attachment may be substantially reversible or permanent, depending on the method(s) utilized. The optical filter 1000′ may be disposed substantially between the patient's mouth and the dental whitening lamp 110. In some embodiments, the optical filter 1000′ may be disposed upon the light guide 112 and may be utilized by attaching to the light guide 112 prior to a whitening procedure. The optical filter 1000′ may include slits 1010′ and 1012′ that correspond to the slots 1132 and 1130 of the light guide 1104 and may be adapted to allow the wing-like formations 1136 and 1134 of a retractor 1138 (not shown) to properly interface with the light guide 1104 and the optical filter 1000′.

In other embodiments, the optical filter 1000′ may be disposed on the dental whitening lamp housing 113, as shown in FIG. 24a. The dental whitening lamp housing 113 may be mounted with an optical filter 1000′ by attaching to the emitting window 113b. The optical filter 1000′ may be adapted to achieve full coverage and/or physical contact with the emitting window 113b so as to act upon all exiting electromagnetic radiation from the dental whitening lamp 110. A light guide 112 (not shown), may be disposed on the lamp housing 113 on the depression 113a, which may dispose the optical filter 1000′ substantially between the emitting window 113b and the light guide 112. This configuration may aid in reducing discomfort to the patient by, for example, increasing the distance between the optical filter 1000′ and the patient’s mouth. As filters and other optically active elements are prone to heating by interaction with electromagnetic radiation, the position of the optical filter further from the patient may aide in reducing the effects of its heating on the patient's comfort.

In further embodiments, the light guide may include an integrated optical filter. FIG. 24b shows an embodiment of a light guide 1000″ that may include an integrated optical window 1020″ on the side proximal to the patient when mounted on a dental whitening lamp assembly 110 (not shown). In other embodiments, the optical window 1020″ may be disposed on the distal side (not shown). The optical window 1020″ may be adapted to achieve any combination of the functions of the optical filter 1000 discussed above.

In embodiments designed to reduce the amount of electromagnetic radiation that exits from the dental whitening lamp, the optical filter window may be constructed from a variety of materials that may be suitable to block some or all of a specific range of frequencies of electromagnetic radiation. Suitable materials may include, for example, various plastics or polymers that are capable of blocking certain forms of electromagnetic radiation. Examples include, but are not limited to, polycarbonate, which may be utilized to partially block ultraviolet (UV) and pass visible light, CR-39 (allyl diglycol carbonate), which may be utilized to block UV and infrared while passing visible light, acrylic, which may partially block infrared above 2800 nm, or any other polymer with suitable optical properties. In addition, other materials such as sodium carbonate containing glass may be utilized to partially block UV while passing visible light.

In some embodiments, the optical filter window may be colored to substantially limit the frequencies of electromagnetic radiation passing through it.

In other embodiments, the optical filter window may be constructed with coatings, additives or doping to achieve the desired filtration characteristics. In some embodiments, opaque additives or thin layer coatings of opaque materials, such as aluminum and titanium oxides, may be utilized to partially block electromagnetic radiation passing through the optical window.

Surface coatings may be created by a variety of methods including, for example, plasma deposition, electroplating, precipitation, thin layer liquid coating, and/or any other suitable method that may produce a thin adherent layer on the desired substrate.

Additives may be incorporated into the optical window by a variety of methods including, for example, complexing within a polymer matrix, doping, chemically modifying the substrate, and/or other methods that may produce a desirable incorporation into the material of the optical window.

In some embodiments, the optical window may include coatings or additives that may allow the window to alter the spectrum of electromagnetic radiation passing through it. Wavelength altering materials or additives may be incorporated to, in general, lengthen the wavelength of specific ranges of electromagnetic radiation passing through the optical window. Wavelength altering materials or additives may include, but are not limited to, organic dyes or fluorophores, such as fluorescein, Texas Red (a sulfonyl chloride derivative of sulforhodamine 101), coumarin derivatives, ethidium bromide, SYBR Green, stilbenes, green fluorescent protein, anthracine derivatives and/or other suitable dyes/fluorophores that may produce desirable wavelength changes. In general, organic heterocyclic compounds may be incorporated to produce alterations in the electromagnetic spectrum of the radiation passing through the optical window.

In further embodiments, the optical window may include photochromic materials or compounds. Photochromics may be utilized to alter the optical properties of the optical window in response to exposure to given ranges of electromagnetic radiation. Photochromics may include, for example, organic photochromics such as triarylmethanes, stilbenes, azastilbenes, nitrones, fulgides, spiropyrans, naphthopyrans and spiro-oxazines when utilizing a polymer substrate for the optical window and inorganic photochromics such as microcrystalline silver halides when utilizing a glass substrate. The optical window may, in some aspects, be modified to darken when exposed to UV by absorbing the radiation and inducing changes in the electron bonding structure of the photochromic, usually causing the previously transparent compound to become opaque or colored, darkening the overall material. The darkened optical window may then at least partially block electromagnetic radiation passing through.

In yet further embodiments, the optical window may include irreversible photochromics that may be utilized to permanently darken the optical window after exposure to UV. Such embodiments may gradually darken during the course of use and may be discarded after reaching a certain level of opacity.

In still further embodiments, the optical window may be modified to reduce the heat effects associated with the dental whitening lamp. The optical window may, for example, include heat conductive materials in its construction and may be modified to direct heat away from the patient. In some aspects, the optical window may be thermally coupled to a heat sink or heat dissipater. Heat conductive materials may include, for example, thin layer metal depositions and/or conductive polymers such as polysulfone. In other aspects, the optical window may include additional insulating layers that may aid in preventing the transmission of heat from the dental whitening lamp to the patient. Insulating materials may include, for example, transparent alumina, polycarbonate, polystyrene and/or any other suitable material that may act as an effective insulator.

In yet still other embodiments, the filter system may be permanently positioned in the direct path of the light source and be electronically controlled to either change or not change the nature of the light coming from the light source. In one embodiment, for example, the filter system may be turned off so that it is transparent to the light coming from the light source so that it may transmit, for example, about 100% of the light of all wavelengths emitted by the light source. In another embodiment, the filter system may have varied effect on the light coming from the light source, for example, only transmitting a wavelength and blocking another wavelength.

There are features that may be achieved with the present positioning methods than those of previously commercially available systems, even those that have been configured for maximizing patient comfort, assuring patients safety of procedure with minimal light spray; offering means of timekeeping and ensuring efficacy of procedure; and offering minimal perception of confinement, leading to perception of minimal duration of procedure, for example, the ZOOM®! illumination systems and BriteSmile® 3000 PB, both available from Discus Dental®, Inc. For the patient, the new features may include: maximizing patient relaxation; allowing for body movement and more head movement not previously achievable. For the dentist, the features may also include those similar to existing system, for example, the BriteSmile® 3000 PB and ZOOM®! illumination systems (both available from Discus Dental®, Inc.): ensuring a fit into dental environment; minimizing footprint of equipment; assuring patient with sophisticated equipment, professional experience and safe procedure; providing for portability, unobtrusive easy to store device, device-handling features, and patient procedure efficacy; providing easy means of patient alignment, and easy cleanup and changeover and easy monitoring and operation.

The light system 1000 having a larger degree of freedom for the patient undergoing any dental procedure may have challenges different from a traditional illumination system. For example, allowing for some variability of emitter light output and voltage drop due to variability of emitter light output and working voltage may impact light uniformity in achieving the target radiometric power at the horizontal extremes of the target zone. This is a challenge for any array design in the optical system. To achieve the target optical power at the horizontal extremes of the target zone, i.e. closer to the back teeth, the array may be easily moved to be closer to the mouth. However, the proximity of the array to mouth and related issues (clinician access, claustrophobia), perceived heating of the skin and clinician access to the mouth, benefits that are possible from being as close to the teeth as possible will thus pose challenges for the emitter array. Also, light spray, as discussed above may pose another challenge.

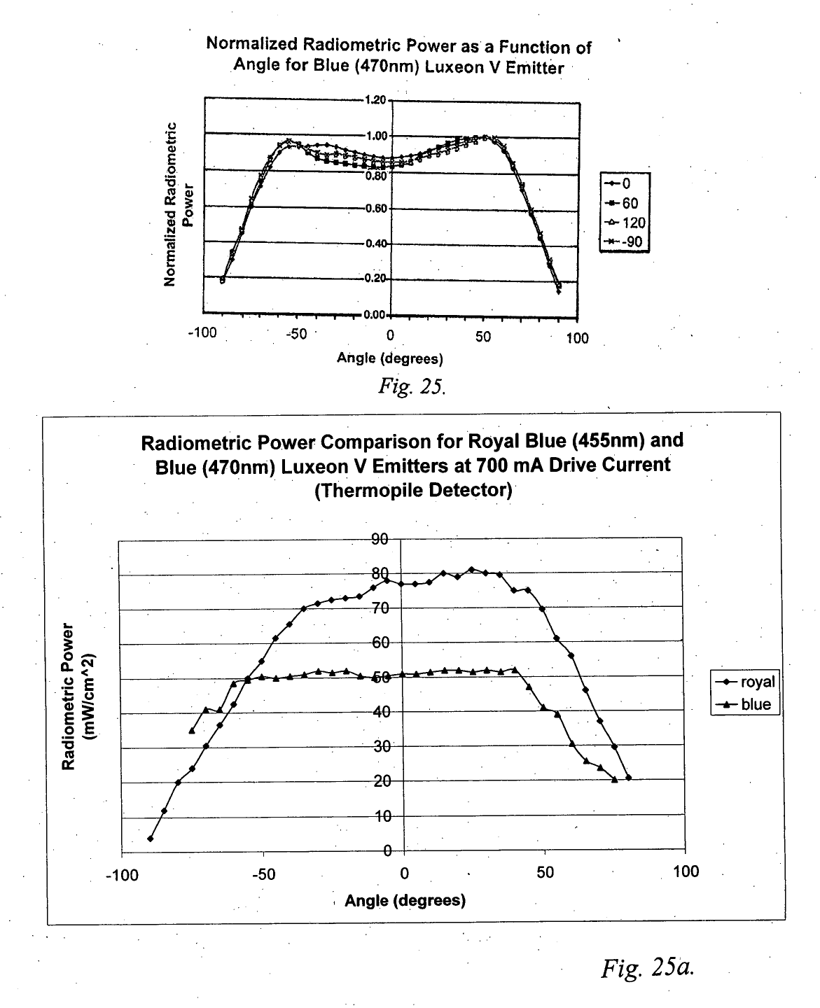

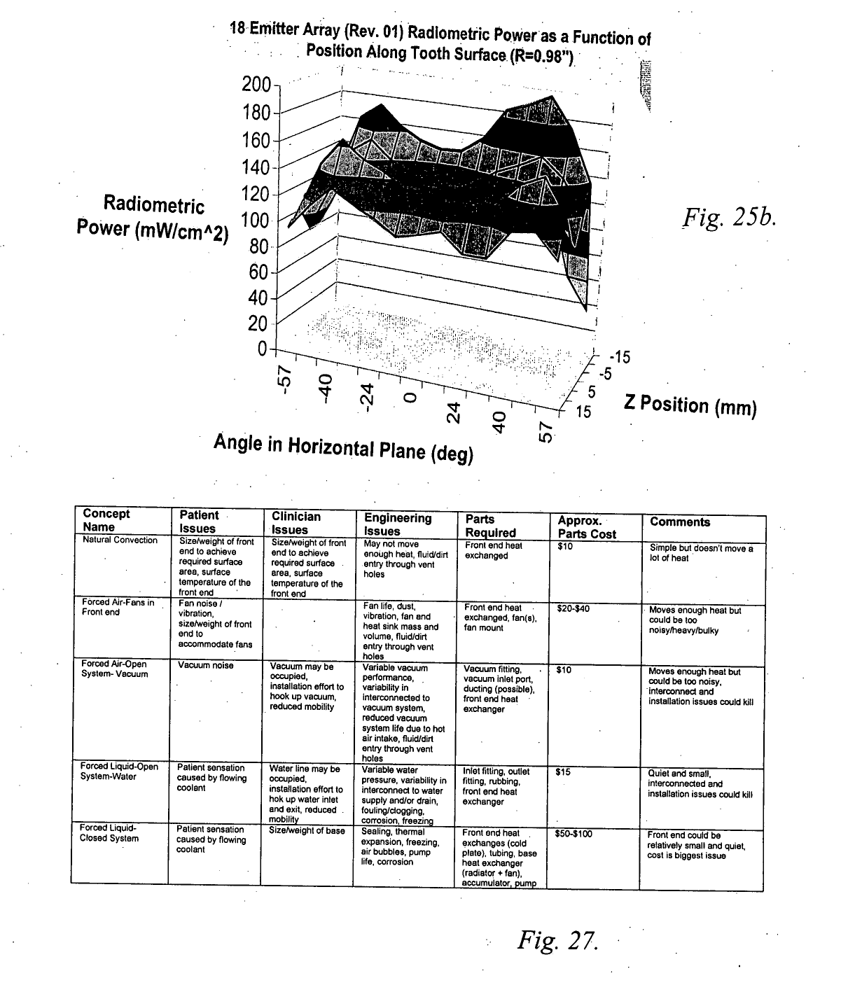

The lamp head 1100 may be, for example, as shown in FIGS. 16, 16a, 18, 18a, 19, 19a, 20 or 20a, a light weight lamp, so that it does not impose too much weight on the patient wearing the dental apparatus without additional support structure. In one embodiment, a single LED, for example, a single Luxeon V emitter may be used as the light source. In another embodiment, an array of emitters may also be used. A normalized radiometric power as a function of angle for the Blue Luxeon V Emitter is shown in FIG. 25, and a Radiometric Power Comparison for a Royal Blue Luxeon Emitter at 700 mA Drive Current (Thermocouple Detector) is shown in FIG. 25a. FIG. 25b shows an 18 Emitter Array Radiometric Power as a function of position along the tooth surface. For example, commercially available Luxeon V emitters are more like floodlights than spotlights, generally speaking, and thus have a wider angular distribution than the Nichia LEDs, for example. This reduced directivity may have the unfortunate consequence of increasing the amount of light coming from an array that may miss the zone of interest and thuds may be “wasted”. The optical efficiency of an array, for example, of Luxeon V emitters, might thus be less than the optical efficiency of an, for example, a 3000PB array from Nichia, which is closer to 80%. This may increase the power consumption required to deliver a given amount of light to the teeth. The negative effect of this wider distribution may be mitigated somewhat by moving the emitters closer to the teeth. This may be made possible by the greatly reduced emitter count in an array. At the same time, those LEDs having more directivity may be used instead.

For positioning the light source 1000 as close as possible to the teeth surface may produce a product with a more challenging cooling application. The wider angular distribution of the emitters may also increase the amount of power to dissipate as heat. A higher working temperature of the emitters may also increase radiant heat emissions, which may at the same time places optical constraints on the emitter array which suggests that the array to be as close to the face as possible.

The headset configuration may also place some volume and weight restrictions on the front end of the lamp system, as noted above. The use of the headset to position the emitter array changes the positioning issue considerably relative to exiting systems for example, Britesmile® 3000 PB system of ZOOM® Whitening systems. The mass to be supported positioning system is reduced, the range of motion has increased, and the maximum overhanging distance at which the mass is supported is also reduced. The structure for supporting the front end mass now involves a load path through the patient's head and neck, which places more emphasis on minimizing the mass of the front end so that any head-mounted structures are to be kept small and light.

The following description illustrated, for example, the desired range of motion for the head-mounted illumination system, the governing equations of static equilibrium, and a mechanical concept for headset adjustment for achieving positioning objectives, as shown in FIGS. 26a, b, c and d and the equations below:

A: Linear adjustment along (x)+1−3 inches

B: Linear adjustment in (y z plane +1−4 inches)

C: Rotational adjustments along (x axis) 45 degrees and

D: Rotational adjustments along (x axis) 45 degrees
AΣTA=Mh1(x1)−Ma(x2)−Mh(x3)−Mc(x3+x4)
BΣTB=Ma(y1)−M(y6)
Where Σ M Total=Mh1+Ma+Mhr+Mc

Cooling of the light source may also be more challenging than a conventional illumination system, as noted above. For example, a cooling system may be called upon to dissipate, for example, approximately 100 Watts of heat in a tightly confined volume where noise, vibration, and weight are also restricted. This may suggest cooling system concepts that rely not on air movement, but on liquid cooling concepts given the relative heat capacities of air and common liquid coolants.

For example, the first order calculations based on the thermal resistances of the Luxeon V emitter package also suggests a heat sink option based on a liquid cooling approach. The phase change heat sink mentioned above may be a suitable choice.

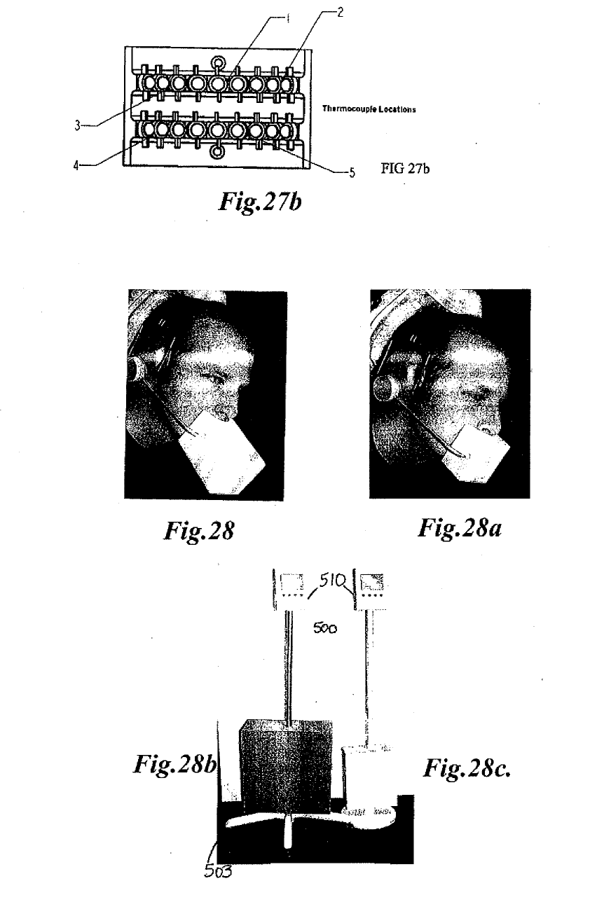

Several other cooling systems may also be used, for example, to address the array heat dissipation challenge may include those options summarized in FIG. 27. Temperature profile plotted against time for an emitter array is shown in FIG. 27a using a thermocouple positioned at 1, 2, 3, 4 and 5, as shown in FIG. 27b. These measurements are explained further in Example 4 below. In addition, the design of the system as well as the headset may also aid in the weight and cooling, as well as the accessibility of the patient to the dental professional. In one embodiment, for example, a single boom or post for a swing away mouthpiece, such as shown in FIGS. 16, 16a, 17, 17a, 17b, 18, 19, 20, and 20a, and wearing it low on the jaw portion may be less obtrusive. In another embodiment, instead of swing away post, a swing down mouth piece may be used, as exemplified in FIGS. 18a and 19a. In a further embodiment, a swing up mouth piece may also be used. These embodiments may also allow for easier access to patient's mouth in between sessions. A single degree of freedom may provide additional benefits such as ease of reset alignment.

Another feature, such as, an open ear-cup, as exemplified in FIGS. 20b and c, may permit the patient to hear without removing the headset. This may also contribute to the light weight of the headset. In these embodiments, the open-ear also allows for ambient hearing and a small insert speaker may allow music listening.

In one embodiment, the cooling system may be configured to be with the mouthpiece, for example FIGS. 28 and 28a. The air-cooled mouthpiece, such as exemplified in FIG. 28, may be more voluminous than a water-cooled mouthpiece as exemplified in FIG. 28a. Water cooled mouthpiece may also offer lower noise operation. Both embodiments of cooling may also face the challenge of dealing with headset weight, and the water cooled base unit, 500, such as exemplified in FIG. 28b, may be larger and heavier than air cooled unit, such as exemplified in FIG. 28c. Some units 500 may have a slim monolithic design, with a case base and extruded body, as shown in FIGS. 30 and 30a. In some embodiments, the base units 500 may have a wide slim monolithic design.

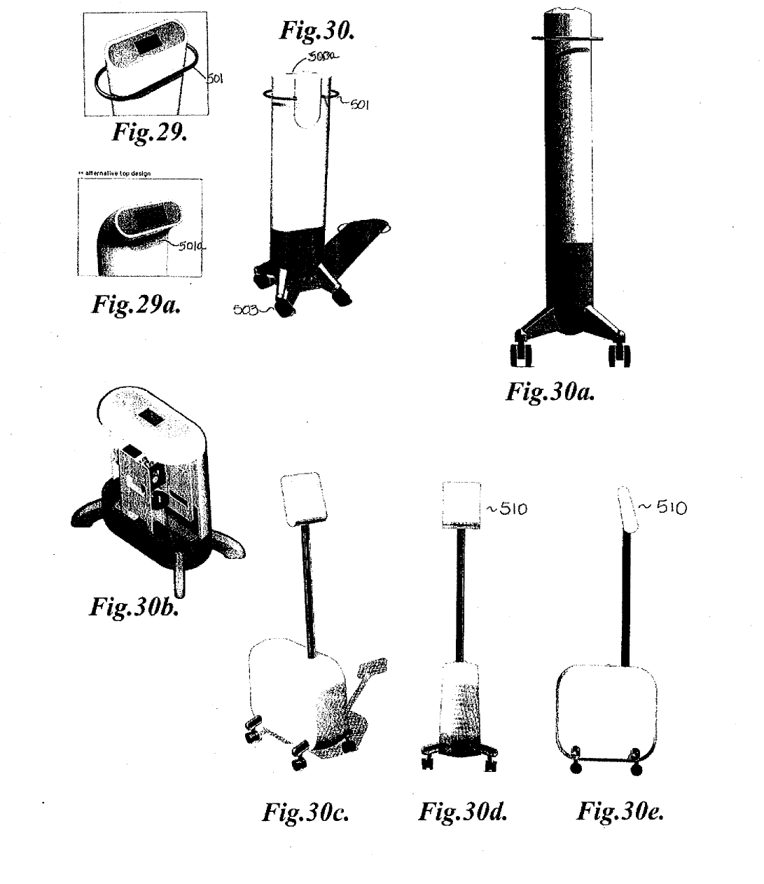

A number of other base units 500 are exemplified below. FIG. 29 shows a glowing top on a straight column. FIG. 29a shows an alternate arcuate top design, such as an angled top, which may allow for easy access. Also, a glowing top and/or column may also be used to indicate interface. FIGS. 28b and 30, in the form of moving castor wheels, 503, and having a handle, 501, or 501a, in the form of a slot, to facilitate moving, as shown in FIGS. 29 and 30, respectfully.

In one aspect, a spot for storing the head set, at the top 500a of the base unit 500, is shown in FIG. 30. In another aspect, the headset may be stored in the back of the body (not shown). In a further aspect, the units 500 may also be equipped with displays 510, as shown in FIGS. 28b, 29c, 30c, 30d, and 30e, which are visible from all sides, for displaying the progress of the treatment and so on. FIG. 30b, c, d, or e has a low center of gravity design, which may be less visible in office environment.

The base unit may be in various other shape and sizes, such as those exemplified in FIGS. 30a (a side view of FIG. 30), 30b, c, d, e, and f. FIGS. 30 d and e show the side, and rear views of FIG. 30c, respectively. FIG. 30f shows the rear of the display 520 having a slot 510a for storing the head set. The headset may have an open-ear design as exemplified in FIG. 20b, as noted above to allow ambient hearing. A small insert speaker in earpiece may also allow for music listening.

Experimental Testing and Results

The following measurements were performed using a prototype. Actual testing was carried out and reported as follows:

### EXAMPLE 1

Individual emitters were characterized in terms of the angular distribution of their radiant emissions. Royal Blue emitters may provide more radio-metric power than Blue emitters, for example, as shown in FIG. 25a. It is possible that some emitters may provide other radiometric power, though on average, an array may function as desired.

### EXAMPLE 2

Following completion of the characterization of individual emitters, a calculation for an emitter array geometry that could deliver the target optical power throughout most of the target zone of use (Zone 1) was carried out.

The prototype of an 18-emitter array geometry which could deliver the target radiometric power (130 mW/cm″2) through out most of Zone 1 using an IDEO optical analysis tool was constructed and radiometric power delivered across the surface of the teeth was measured. As shown by the graph in FIG. 25b, the prototype array delivered the target optical power throughout much of Zone 1. FIG. 25b shows a plot of radiometric power as a function of position along tooth surface. These results from the full emitter array optical measurements were encouraging, with much of Zone 1 falling within the target power range. These results gave positive results for an effective teeth whitening device utilizing an array of approximately 20 LuxeonV emitters.

Experiment

Thermal Testing

A breadboard of a liquid cooling system for an array was fabricated and tested. Results were encouraging, indicating that a liquid cooling system could be an effective means of dissipating the heat of the emitter array with considerably less added volume than other cooling system concepts.

Liquid and forced air/fan cooling system bread boards were fabricated and tested with a full emitter array. Only limited data was obtained for the initial air cooling test because the array mounting block rapidly reached unsafe operating temperatures (90 deg C.) with the first air cooling breadboard.

Results for the liquid cooling breadboard are shown in the chart in FIG. 27a. Temperature measurements were taken at five locations throughout the emitter array at the base of the emitters, as shown in FIG. 27b. The target temperature was set at 45 C based on a maximum working junction temperature of 120 C, a thermal resistance from junction to case of 15 deg C. per Watt and power dissipation of 5 Watt per emitter.

These results show that a liquid cooling system consisting of cold plate, radiator, radiator fan, accumulator, and pump is effective in dissipating the heat from the Vader emitter array.

Experiment 4

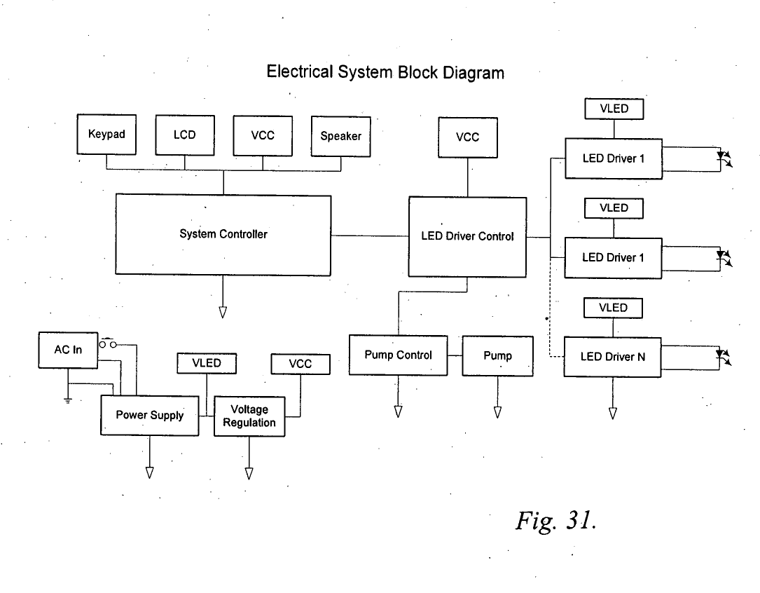

FIG. 31 shows a block diagram of a top level Electrical System for the illumination product and a discussion of the primary novel issues, such as the design of appropriate driver circuitry for an array of LuxeonV emitters.

Electrical Architecture

I. The hardware design for the prototype included the following elements:

1. Keypad—A 14 pad keypad was used to duplicate the keypad functionality of the present system.

2. Speaker

An exiting speaker and speaker circuitry, such as that used in BriteSmile® 3000PB was used and the details are presented below.

3. Main controller

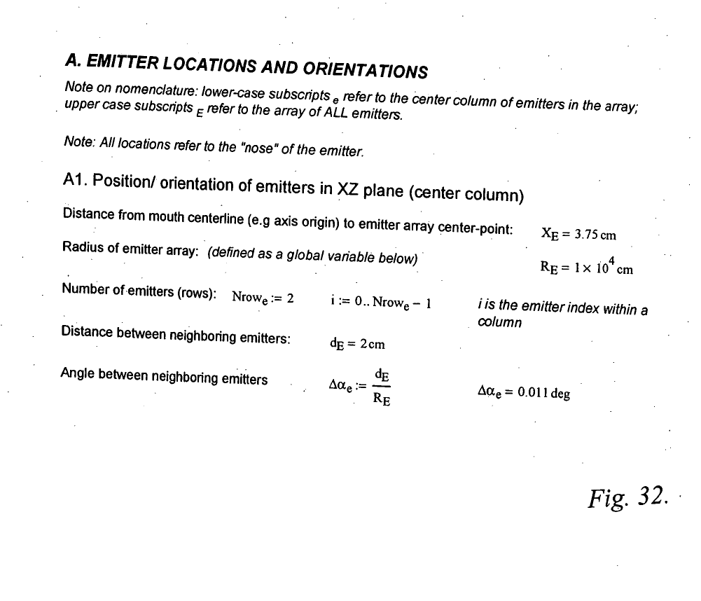

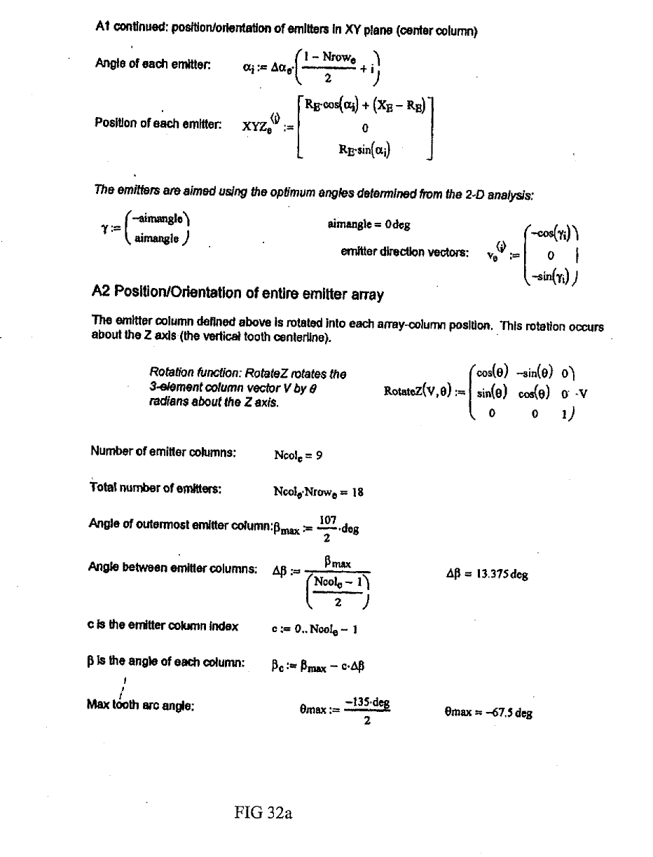

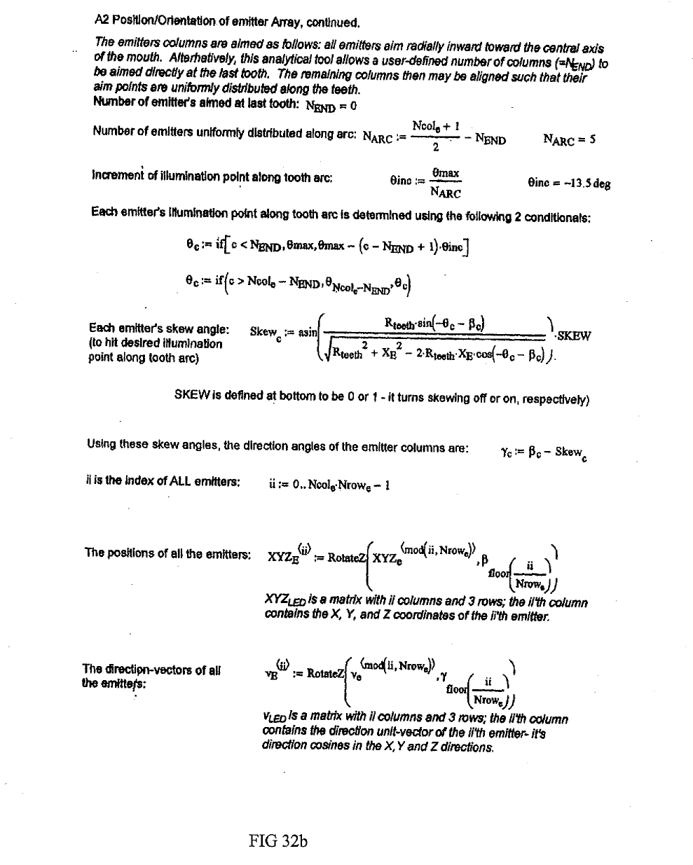

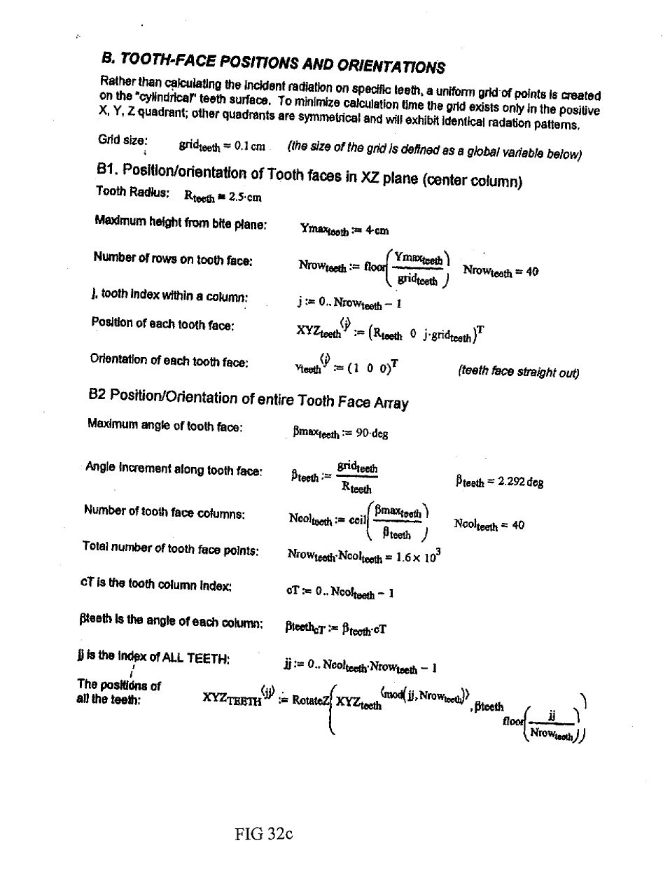

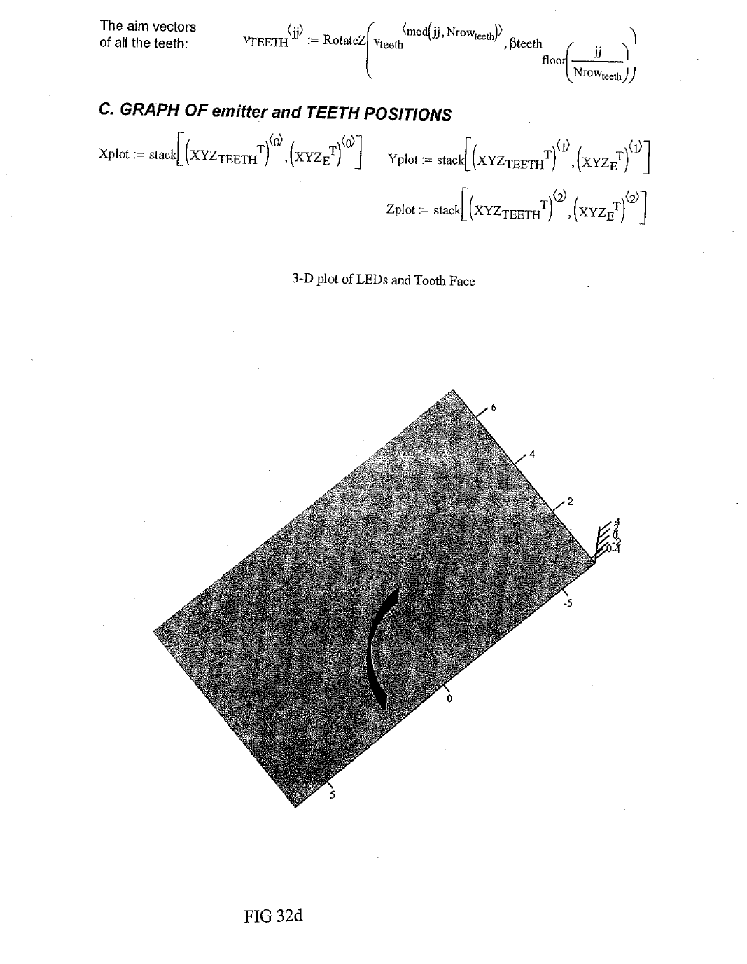

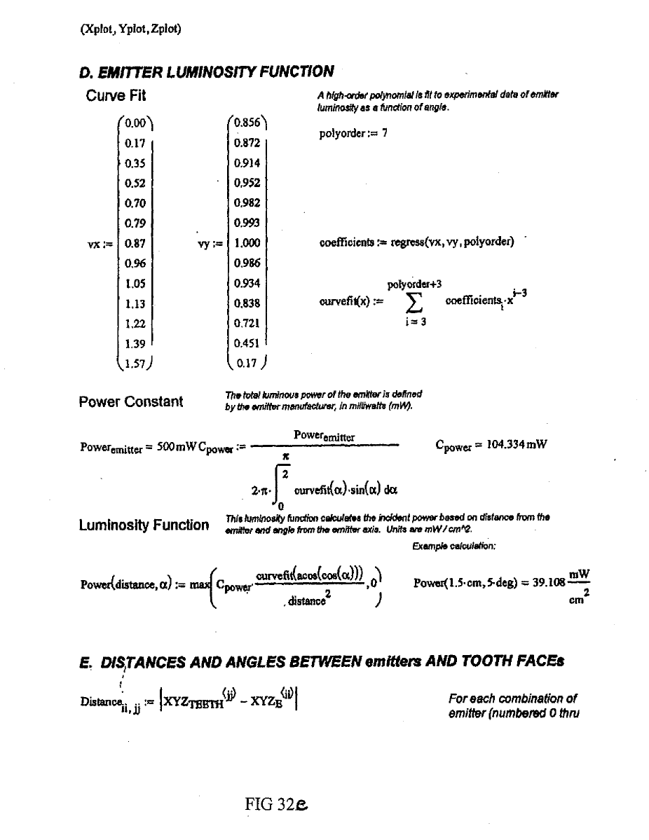

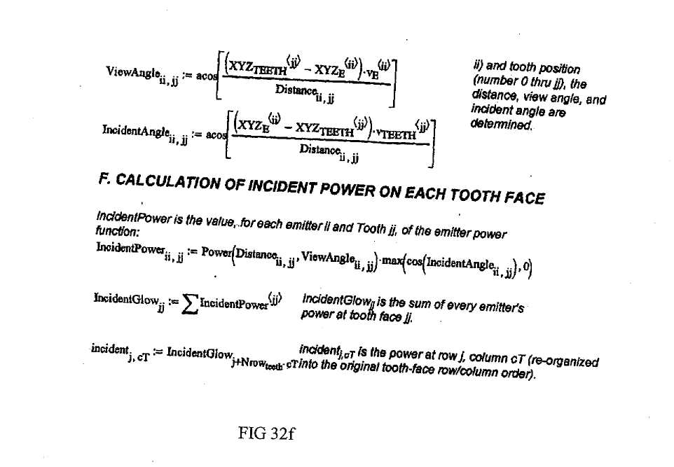

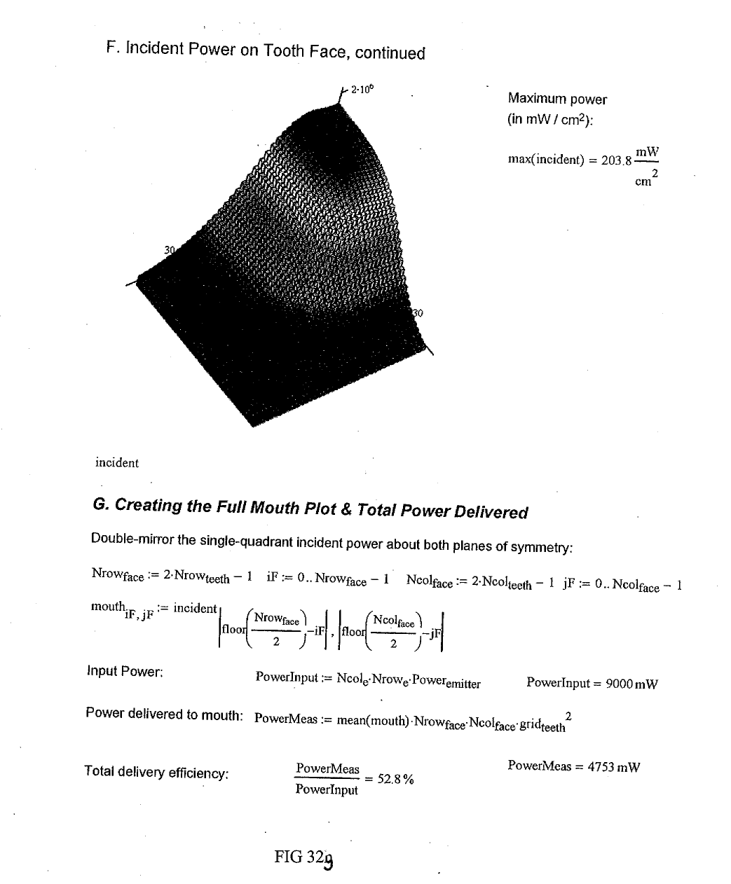

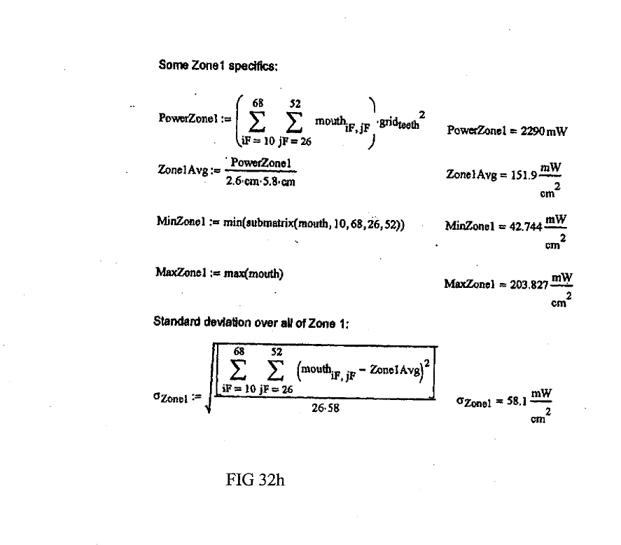

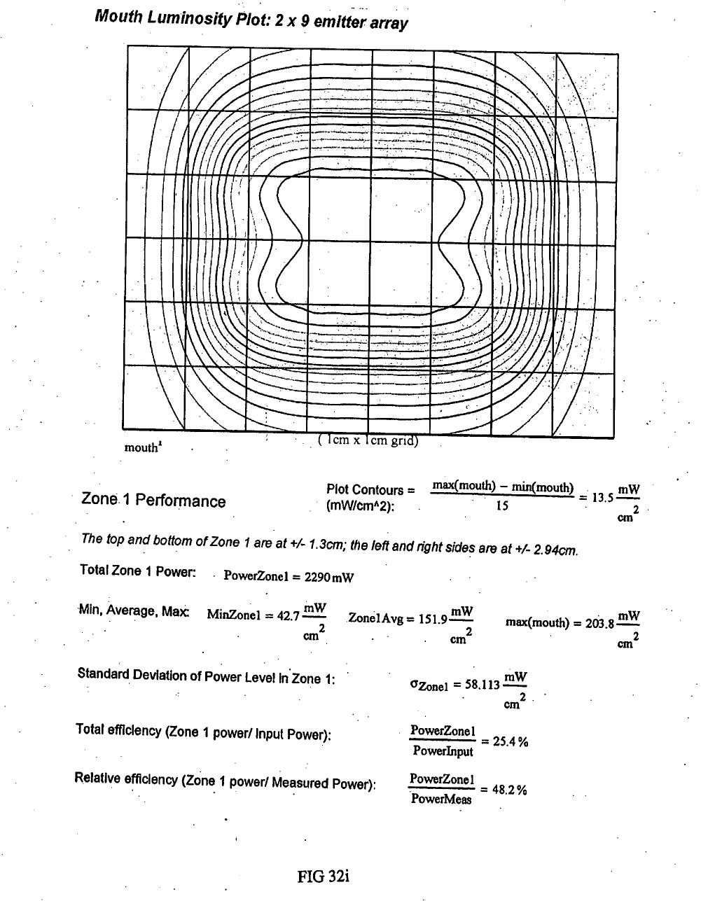

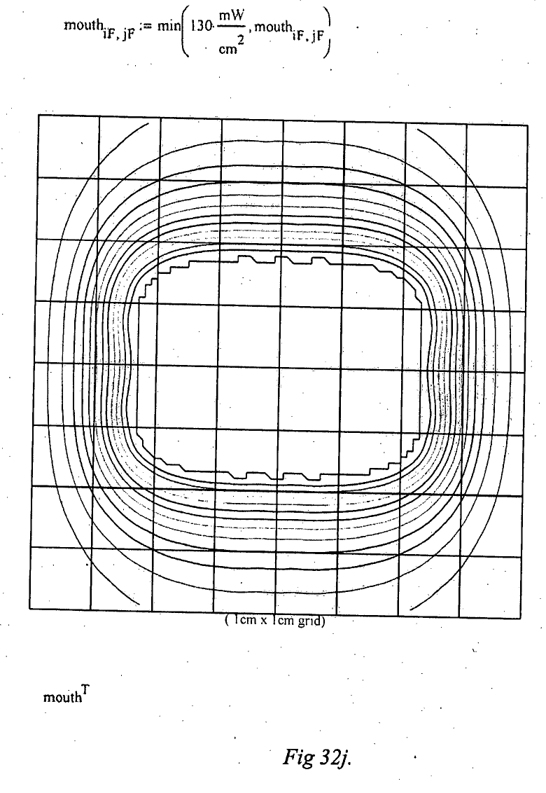

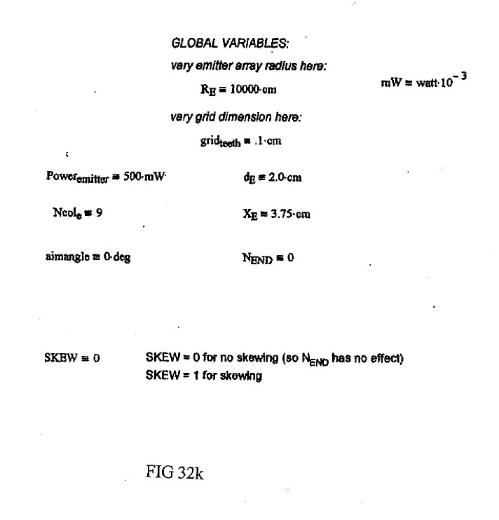

The main controller and associated circuitry of BriteSmile® 3000 PB was used in the prototype. LCD—The LCD and LCD interface was also the same as used in BriteSmile® 3000 PB. Interface to LED controller—The interface to the LED controller was a serial port interface. LED driver control—There were 18 high power LEDs to operate, as exemplified. These LEDs were driven either individually or in pairs, as selected. This decision would thus affect the choice of power supply voltage. For LEDs that were driven in pairs, a power supply voltage greater than 16 volts was used. The LED driver control created a current reference command that caused the LED current of each LED to be set to the appropriate current determined by calibration, as shown in FIGS. 32-32k.

4. Pump control

Circuitry was provided to monitor the operation of the pump for the liquid cooling system, such that if the cooling system was not operational, the LEDs would be disabled.

II. Software

1. User Interface

The user interface used was similar to that of the BriteSmile® 3000 PB.

2. Test Code

The test code was modified to reflect new LED operation.

3. Calibration Code

Presently, the calibration code used in BriteSmile® 3000PB determined a single calibration value that was used to set the LED drive value for the entire head. This was presently facilitated by binning LEDs such that the current to light output of LEDs within a given head was similar enough to provide even illumination. Binning of LEDs was used for the new design to allow for a similar simple calibration procedure.

4. LED Driver Options

There was a fairly high degree of variability in light output and forward voltage among LuxeonV emitters. This section describes three options.

a. Bin LEDs by light output vs. current

This approach involved designing a programmable current circuit and using a single current reference signal for calibrating the entire head at once.

b. Do not bin LEDs

This approach involves designing a programmable current circuit, using multiple reference voltages (up to 18), and calibrating individual LEDs or groups of LEDs. The following programmable current circuit options exit:

The working voltage of a given LED could be varied by +/−20% from nominal. This constrained the power supply choice for a fixed voltage source circuit. The highest voltage LED with a fixed current sense resistor would have the lowest maximum current capability. This set the resistor value for a given power supply volt age. The lower the supply voltage, the lower would be the overall power dissipation. When a voltage controlled current source circuit was used, the following system power implications were seen:

LED drive voltage and system power dissipation for 18 LEDs are shown below:

15V 189 Watts (includes LED power)

12V 151 Watts (includes LED power)

10V 126 Watts (includes LED power)

LED forward voltage drop are shown below:

LED minimum voltage 5.43 volts at 700 ma

LED typical voltage 6.84 volts at 700 ma

LED maximum voltage 8.31 volts at 700 ms

LED power is shown below:

Minimum 68 Watts (all 5.43 volts)

Typical 86 Watts (all 6.84 volts)

Maximum 105 Watts (all 8.31 volts)

### EXAMPLE 5

The experiment related to the positioning of the illumination system has been fully illustrated in FIGS. 26a, b, c and d.

Analysis

The 3-D Emitter Incident Power Study was carried out as follows:

This mathcad file determined the distribution of illumination power over the patient's teeth and gums.

The coordinate used for the analysis system was centered on the mouth centerline, at the center of the teeth radius (approx 0.98 inch or 2.5 cm radius). From this central point, the X-axis points forward (out of the mouth between the teeth), the V-axis points leftward (thru the cheek) and the Z-axis points upward (thru the top of the mouth). Thus the following planes are defined:

XY=‘bite plane”

XZ=patient's “plane-of-symmetry”

YZ=“backplane” of mouth

It is within this coordinate system that all positions and orientation vectors are defined below.

Section A determines the positions and orientation vectors of the array of emitters.

Section B determines the positions and orientation vectors of points on the tooth-face surface.

Section C presents a 3-dimensional graph of the emitters and the tooth-face surface points.

Section 0 presents the emitter radiated power function.

Section E calculates the distances and angles between each emitter and the tooth faces.

Section F calculates and presents the total radiated power on each tooth face.

Section G presents the results for the entire mouth.

The various equations and calculations are shown in FIGS. 32-32k.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. An apparatus for positioning a dental illumination system comprising:
a lamp system comprising a lamp head;
at least one reference device adapted to removably mechanically couple to said lamp head;
wherein said lamp system is adapted to be worn on at least a portion of a person's head, permitting such person some movement during treatment without disrupting the treatment process.

2. The apparatus of claim 1 wherein said reference device comprises a light distributor.

3. The apparatus of claim 1 wherein at least a portion of said reference device is adapted to be worn intraorally.

4. The apparatus of claim 3 wherein said reference device is a retracting device adapted for retracting at least one portion of a subject's lips.

5. The apparatus of claim 1 wherein said lamp system comprises a headphone or an eyewear frame structure.

6. The apparatus of claim 2 wherein said light distributor comprises at least one light pipe, at least one light guide; a mouthpiece, a tongue illuminator, an illumination plate, a dental tray, a dental floss or combinations thereof.

7. The apparatus of claim 1 wherein said lamp head comprises at least one formation adapted for engaging the reference device for positioning the lamp system at a predetermined distance from the reference device.

8. The apparatus of claim 7 wherein the formation comprises a spacer.

9. The apparatus of claim 2 wherein said light distributor comprises at least one formation that inter-engages the lamp head as the light distributor and lamp head become apposed.

10. The apparatus of claim 8 wherein the spacer comprises formations that removably inter-engages the lamp head as the spacer and the lamp head become apposed.

11. The apparatus of claim 1 wherein said lamp system comprises an illumination frame having at least one light source in a geometric arrangement.

12. The apparatus of claim 1 wherein said lamp system comprises at least one light source selected from the group consisting of a halogen bulb, semiconductor light emitting devices, light-emitting chips, an LED array, a fluorescent bulb and combinations thereof.

13. The apparatus of claim 8 wherein said spacer is removably attached to said lamp head.

14. The apparatus of claim 1 wherein said lamp system comprises at least one heat sink comprising a phase change material.

15. A dental illumination system comprising:
an adjustable frame adapted to be worn on a person's head;
a lamp head adjustably coupled to said frame, said lamp-head comprising a housing; and
at least one light source positioned within said housing;
wherein said adjustable frame comprises at least one formation being adapted to mechanically couple said lamp head to said frame for facilitating the illumination of an oral cavity by said light source.

16. The dental illumination system of claim 15 wherein said frame comprises a head gear adapted for supporting the dental lamp, said head gear comprises an arm extending from the head gear and attached to the lamp head.

17. The dental illumination system of claim 15 wherein said formation comprises a hingeably attached arm.

18. The dental illumination system of claim 15 wherein said frame comprises a headphone or an eyewear frame structure.

19. The dental illumination system of claim 15 wherein said system further comprises at least one reference device adapted to removably mechanically couple to said lamp head.

20. The apparatus of claim 19 wherein said at least a portion of said reference device is adapted to be worn intraorally.

21. The apparatus of claim 20 wherein said reference device comprises a retracting device adapted for retracting at least one portion of a subject's lips.

22. The dental illumination system of claim 17 wherein said arm comprises at least one formation spaced away from one end of said arm, wherein said at least one formation comprises a joint adapted for coupling the arm to the frame to form an articulated support system.

23. The dental illumination system of claim 22 wherein said joint is adapted to maintain the arm in a fixed position and orientation with respect to the frame.

24. An illumination system comprising:
a lamp head housing having an internal surface and a cavity within said housing, said internal surface including a first edge, said first edge defining a first aperture;
a light module being disposed within said cavity, said light module comprising a first reflector having an axis of illumination passing through said first aperture; and
a mechanical coupling device adapted to couple said housing to a frame for facilitating the support of the light source on the head of a person.

25. The illumination system of claim 24 wherein said coupling device comprises an arm.

26. The illumination system of claim 25 wherein said lamp head comprise an illumination frame having at least one light source in a geometric arrangement.

27. The illumination system of claim 24 further comprising an optical filter system adapted to modify the optical and/or physical properties of the light.

28. The illumination system of claim 27 wherein said filter system is swingably attached in front of the first aperture.

29. The illumination system of claim 27 wherein said filter system is attached directly to the lamp head housing.
